(19) United States
(12) Patent Application Publication
(10) Pub. No.: US 2004/0231000 A1
(43) Pub. Date: Nov. 18, 2004

(54) Video aperture management

(76) Inventors: Anuj B. Gossalia, Redmond, WA (US); Steve Pronovost, Redmond, WA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/779,272

(22) Filed: Feb. 13, 2004

Related U.S. Application Data
(60) Provisional application No. 60/448,400, filed on Feb. 18, 2003.

(51) Int. Cl. H04N 7/173; H04N 7/16

(52) U.S. Cl. 725/132; 725/133; 725/140; 725/141; 725/152

(57) ABSTRACT

A video memory manager manages video data in a computer environment having a main processing unit for executing an operating system and an application, a system memory, and a graphics processing unit having an aperture that maps, in a tiled manner, between a portion of system memory and the graphics processing unit. The video memory manager manages memory for video data in a heap located in a private address space of the application. The video memory manager allocates and maintains virtual memory mappings between the allocated virtual memory, the heap, and the aperture such that both the main processing unit and the graphics processing unit can view the data in an untiled manner.

### CROSS-REFERENCE TO RELATED APPLICATIONS

This application claims priority of U.S. Provisional Application Ser. No. 60/448,400 entitled “Video Memory Manager Rectangular Heap,” filed Feb. 18, 2003. This application is related to co-pending application U.S. patent application Ser. No. ______ (Attorney Docket No. MSFT-2812/304049.02) entitled “Video Memory Management,” filed Dec. 30, 2003, and incorporated by reference herein in its entirety.

### FIELD OF THE INVENTION

The invention relates generally to the field of computing, and, more particularly, to graphics processing units having apertures that can map graphics data in a tiled manner.

### BACKGROUND OF THE INVENTION

The use of graphics in computers has increased dramatically over the years due to the development of graphics based user-friendly application programs and operating systems. To support the computing requirements associated with graphics, computer component manufacturers have developed specialized graphics processing units (GPUs) to offload some of the intense graphics computing demands from the central processing unit (CPU) to these specialized GPUs. Many of these GPUs are implemented on a Peripheral Component Interconnect (PCI) compatible card and include local graphics memory (also referred to herein as video memory) on the card itself. This local video memory enables the GPU to process graphics more quickly.

Some GPUs include an “aperture” that provides an address mapping so that the GPU can access a portion of system memory. Some of these GPUs (e.g., some Intel i845 chipsets with an integrated GPU) perform the aperture address mapping in a tiled or swizzle fashion, thereby resulting in a discontiguous distribution of graphics data in the system memory. When the GPU addresses the system memory through the aperture, there is no concern because the aperture mapping provides a linear view of the graphics data to the GPU. Also, when the CPU addresses the system memory through the aperture, there is no concern because, again, the aperture mapping provides a linear view of the graphics data to the CPU. However, when graphics data is evicted from the aperture mapping to the system memory (with no aperture mapping), the CPU can no longer view the graphics data in a linear fashion. Instead, the CPU sees the graphics data arranged in a discontiguous fashion. Access of such discontiguous graphics data can result in slower processing times. Also, there is a need to provide an application with a linear view of an allocation whether or not the allocation is located in the aperture.

Therefore, there is a need for systems and methods to address the aforementioned tiled aperture address mapping.

### SUMMARY OF THE INVENTION

A video memory manager manages video data in a computer environment having a main processing unit, a system memory, and a graphics processing unit having an aperture that maps video data, in a tiled manner, between system memory and the graphics processing unit. The video memory manager manages memory for video data in a heap allocated in a private address space of the application. The video memory manager allocates and maintains virtual memory mappings between the allocated virtual memory, the heap, and the aperture such that both the main processing unit and the graphics processing unit can view the data in an untiled manner, even when the data is evicted from the aperture mapping. Static allocations may be treated different from dynamic allocation because static allocations are directly accessible by the main processing unit and dynamic allocations are not directly accessible by the main processing unit. Other features are described below.

### BRIEF DESCRIPTION OF THE DRAWINGS

The foregoing summary, as well as the following detailed description of illustrative embodiments, is better understood when read in conjunction with the appended drawings. For the purpose of illustration, there is shown in the drawings illustrative embodiments of the invention; however, the invention is not limited to the specific embodiments described. In the drawings:

FIG. 1 is a block diagram of an illustrative computing environment in which aspects of the invention may be implemented;

FIG. 2 is a block diagram showing more illustrative details of the computing environment of FIG. 1 in which aspects of the invention may be implemented;

FIG. 3 is a block diagram showing an illustrative address space for the computing environment of FIG. 1;

FIGS. 4a and 4b are block diagrams showing the effect of tiled versus linear aperture mapping in an illustrative address space;

FIG. 5 is a flow diagram showing an illustrative method for managing static allocations of video data in an aperture that maps data in a tiled fashion, in accordance with an embodiment of the invention;

FIG. 6 is a block diagram showing an illustrative mapping resulting from the illustrative method of FIG. 5;

FIG. 7 is a flow diagram showing another illustrative method for managing static allocations of video data in an aperture that maps data in a tiled fashion, in accordance with an embodiment of the invention;

FIG. 8 is a block diagram showing an illustrative mapping resulting from the illustrative method of FIG. 7;

FIG. 9 is a flow diagram showing another illustrative method for managing static allocations of video data in an aperture that maps data in a tiled fashion, in accordance with an embodiment of the invention;

FIG. 10 is a block diagram showing an illustrative mapping resulting from the illustrative method of FIG. 9;

FIG. 11 is a flow diagram showing an illustrative method for managing dynamic allocations of video data in an aperture that maps data in a tiled fashion, in accordance with an embodiment of the invention;

FIG. 12 is a flow diagram showing another illustrative method for managing dynamic allocations of video data in an aperture that maps data in a tiled fashion, in accordance with an embodiment of the invention;

FIG. 13 is a block diagram illustrating an allocation spanning multiple pages of the heap and multiple pages of the aperture, in accordance with an embodiment of the invention;

FIG. 14 is a flow diagram showing another illustrative method for managing dynamic allocations of video data in an aperture that maps data in a tiled fashion, in accordance with an embodiment of the invention;

FIG. 15 is a block diagram illustrating an allocation spanning multiple pages of system memory and multiple pages of the aperture, in accordance with an embodiment of the invention;

FIG. 16 is a block diagram illustrating a fenced region around an allocation in the aperture, in accordance with an embodiment of the invention;

FIG. 17 is a flow diagram showing another illustrative method for managing dynamic allocations of video data in an aperture that maps data in a tiled fashion, in accordance with an embodiment of the invention;

FIG. 18 is a flow diagram showing another illustrative method for managing dynamic allocations of video data in an aperture that maps data in a tiled fashion, in accordance with an embodiment of the invention;

FIG. 19 is a block diagram showing an illustrative mapping resulting from the illustrative method of FIG. 18;

FIG. 20 is a block diagram of an illustrative system for managing allocations of video data in an aperture that maps data in a tiled fashion and for validating a direct memory access stream wherein one aperture is shared by multiple applications, in accordance with an embodiment of the invention;

FIG. 21 is a flow diagram of an illustrative method for managing allocations of video data in an aperture that maps data in a tiled fashion and for validating a direct memory access stream wherein one aperture is shared by multiple applications, in accordance with an embodiment of the invention;

FIG. 22 is a block diagram of an illustrative system for managing allocations of video data in an aperture that maps data in a tiled fashion and for validating a direct memory access stream wherein one aperture is used by each application, in accordance with an embodiment of the invention; and

FIG. 23 is a flow diagram of an illustrative method for managing allocations of video data in an aperture that maps data in a tiled fashion and for validating a direct memory access stream wherein one aperture is used by each application, in accordance with an embodiment of the invention.

### DETAILED DESCRIPTION OF ILLUSTRATIVE EMBODIMENTS

Computer System

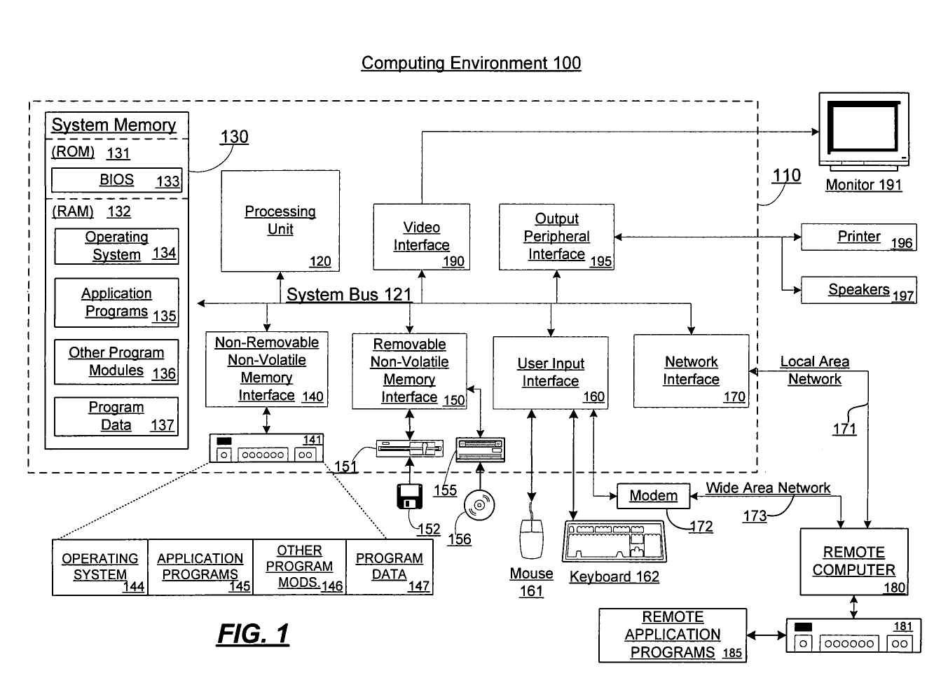

FIG. 1 shows an illustrative computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the illustrative operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an illustrative system for implementing the invention includes a general purpose computing device in the form of a computer 110. Components of computer 110 may include, but are not limited to, a processing unit 120 (e.g., central processing unit CPU 120), a system memory 130, and a system bus 121 that couples various system components, including coupling system memory 130 to processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. System memory 130 may be separated into kernel memory (which is a memory protected by the operating system 134) and application or process memory (which is a memory used by application programs 135 and is subject to less protection).

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the illustrative operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are illustrative and other means of establishing a communications link between the computers may be used.

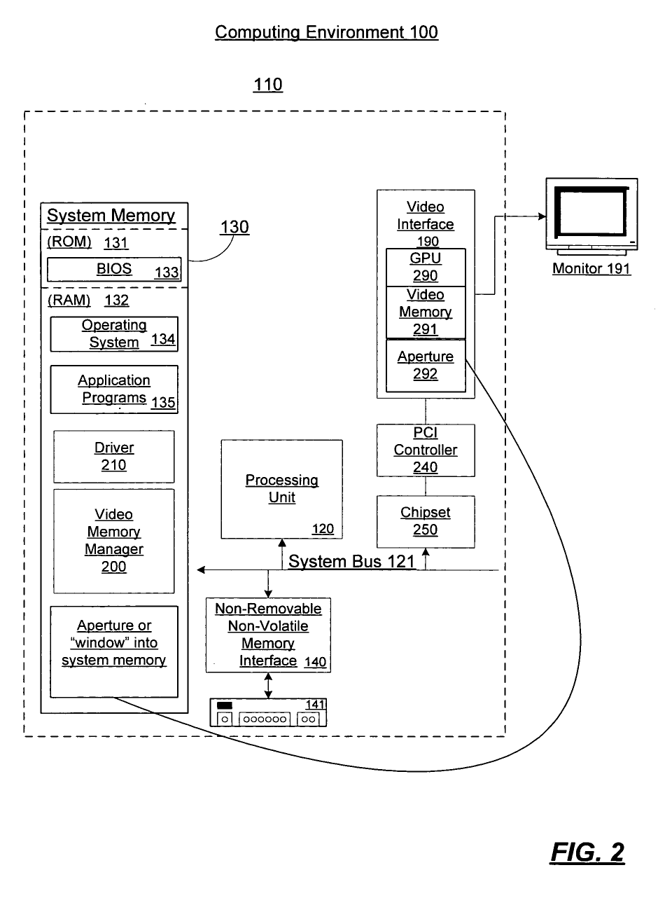

FIG. 2 shows more details of the illustrative computing environment 100 of FIG. 1. As shown in FIG. 2, video interface 190 includes a graphics processing unit (GPU) 290. The GPU 290 typically includes a specialized processor for processing graphics. The GPU 290 typically includes a graphics pipeline for high-speed processing of graphics information. Inclusion of GPU 290 may allow offloading of the intense graphics computational demands from CPU 120. As shown, GPU 290 includes video memory 291. Video memory 291 may store graphics information useful for generating graphics for display on monitor 191.

Video interface 190 communicates with other devices in computing environment 100 via Peripheral Component Interconnect (PCI) controller 240 and chipset 250. GPU 290 may include an aperture 292 that functions as a high-speed “window” into system memory 130. That is, aperture 292 of GPU 290 maps to corresponding system memory 130 and allows GPU 290 to view system memory 130 via a virtual memory addressing scheme. This allows GPU 290's view of a memory allocation to appear contiguous, even though the particular allocation may actually be located in discontiguous physical system memory pages. While a conventional GPU typically directly addresses video memory, GPU 290 may addresses various memory storage devices in computing environment through video memory manager 200. That is, video memory manager 200 may provide address translation for GPU 290, thereby virtualizing memory for GPU 290. Video memory manager 200 may include an address translation mechanism to convert between virtual addresses and physical memory addresses. In this manner, GPU 290 may be shared between multiple applications at the same time. Video memory manager 200 (also referred to herein as VidMm) may reside in a kernel mode component of operating system 134.

Such virtualization is made possible because GPU 290 only needs a subset of the allocated memory to be present in local video memory 291 or non-local video aperture 292 at any given time. For example, when drawing a triangle for an application, GPU 290 only needs to have access to the texture for that triangle, not the entire set of texture used by the application. Thus video memory manager 200 may attempt to keep the correct subset of graphics content visible to GPU 290 and move unused graphics content to an alternative medium (e.g., system memory 130).

Surfaces

A surface represents a logical collection of bits allocated on behalf of an application. The content of a surface (i.e., the logical collection of bits) is typically under the control of the application. A surface may be constructed out of one or more video memory allocations. These video memory allocations may or may not be directly visible to the application even though the application can ultimately control the content. An example of a surface having more than one video memory allocation is a palletized texture on hardware that doesn't support this type of texture. The driver could use one video memory allocation to hold the content of the texture in palletized mode, and use a second video memory allocation to hold the content of the texture in expanded mode. Surfaces may be dynamic or static—the difference is how the application accesses the content of that surface.

Static Surfaces

A static surface is a surface for which the application doesn't have direct CPU access to the bits of the surface, even though it can control the content indirectly. An application may understand the logical format of the surface and control the content, for example, through a GPU operation. ‘Static’ means that the content of the surface should only change if those surfaces are the target of a GPU operation. Static surfaces may be used to allocate textures, vertex buffers, render targets, z-buffers, and the like. A static surface may include of multiple static video memory allocations, described in more detail below.

Dynamic Surfaces

Dynamic surfaces are similar to static surfaces, except that an application can request to have direct CPU access to the bits of the surface. Dynamic surfaces allow the application to access the content of the surface through GPU operation and through direct CPU access. A dynamic surface includes at least one dynamic video memory allocation and can include static video memory allocations, described in more detail below.

Video Memory Allocation

As stated above, a video memory allocation is a collection of bits that holds some content for a surface. A static video memory allocation is a video memory allocation that, in general, is not directly accessed by CPU 120. A dynamic video memory allocation is a video memory allocation that may be directly accessed by CPU 120, A dynamic surface, therefore, includes at least one dynamic allocation while a static surface does not include a dynamic allocation.

A physical video memory allocation is an allocated range in a particular physical video memory segment of video memory 291.

A non-local aperture allocation is an allocated range in the physical space controlled by aperture 292. It should be understood that this type of allocation can't by itself hold any bits. It's only a physical space allocation and that physical space in aperture 292 is redirected to the system memory 130 (e.g., pages holding the video memory allocation data).

Video Memory Manager

Video memory manager 200 performs various functions during memory management, such as, for example, allocation and deallocation of physical memory, allocation and deallocation of virtual memory, protection of memory, eviction of data from one data storage device to another, and the like. Video memory manager 200 may use one or a combination of a virtual memory manager, a physical memory manager, and a non-local aperture manager to perform various functions related to memory management. While video memory manager 200 is described as having three memory managers, video memory manager 200 may include any number of memory managers and the functionality may be apportioned between the various memory managers in any convenient fashion.

The physical memory manager manages physical video memory 291 and a portion of physical system memory 130. The physical memory manager attempts to find an appropriate free range of contiguous physical video memory 291 when a video memory allocation is requested. When physical video memory 291 is full, the physical memory manager (in conjunction with the virtual memory manager) may evict an allocation (including graphics data) to system memory 130. The physical memory manager may also determine which allocation to evict when physical video memory 291 is full. The address space of physical video memory 291 can be divided into one or more segments and each segment may be managed separately as a linear heap, pages, and the like. Driver 210 may decide how each segment is managed.

The non-local aperture manager manages aperture 292. The non-local aperture manager doesn't actually “allocate” any memory; rather, the non-local aperture manager allocates an address range in aperture 292 itself. Aperture 292 is really an address space and thus the non-local aperture manager doesn't really allocate memory but allocates address space to be redirected (mapped) to some actual system physical memory in system memory 130. The non-local aperture manager may manage the space inside the aperture on a page basis. Once a range is allocated, the non-local aperture manager 330 locks a system memory surface into place and maps it through aperture 292. The non-local aperture manager may call a driver responsible for aperture 292 to do the mapping on its behalf.

When the bits of an allocation reside in system memory 130, they can't be directly accessed by GPU 290 unless the physical system pages forming the buffer of system memory 130 are made visible through aperture 292. In that state, the dynamic video memory allocation will be associated with a range of non-local aperture address space allocated by the non-local aperture manager. The non-local aperture hardware of GPU 290 redirects that address space to the appropriate physical pages in system memory 130.

Video memory manager 200 may make an allocation visible through the aperture 292 by making sure the allocation bits are in system memory 130 then locking the pages forming the allocation in physical system memory 130 so that the paging system doesn't send them to disk. Once the pages are locked, video memory manager 200 may allocate a range in the aperture 292 that is visible to the GPU 290 and reprogram the aperture to redirect that range to the physical system memory pages. This allocation of address space in aperture 292 may be done through the non-local aperture manager.

The virtual memory manager may perform dynamic and static video memory allocations. The virtual memory manager creates a hierarchy of data storage for graphics data. Thus, as described above, a video memory allocation may not be resident in physical video memory 291. Instead, the bits of a video memory allocation might be in physical system memory 130 (and may be visible or not visible through aperture 292), or even on hard disk 141 accessible via the page file system of operating system 134.

Video memory manager 200 may arbitrate the resources among the applications by tracking the allocations made on behalf of every process and balancing resource usage among the processes. Video memory manager 200 may implement the virtualization of memory through the use of a video memory manager 200 created handle. Clients (e.g., application 135) of video memory manager 200 may reference addresses and allocations through the use of the handle. In this manner, a client may not actually know the physical address of the graphics data. Video memory manager 200 may convert a given handle to an address visible to GPU 290.

Tiled Mapping

Some GPUs perform aperture address mapping in a tiled or swizzle fashion, thereby resulting in a discontiguous distribution of graphics data in system memory 130. When GPU 290 addresses system memory 130 through aperture 292, there is no concern about the tiling because the aperture mapping provides a linear view of the graphics data to GPU 290. Also, when CPU 120 addresses system memory 130 through aperture 292, there is no concern about the tiling because the aperture mapping provides a linear view of the graphics data to CPU 120.

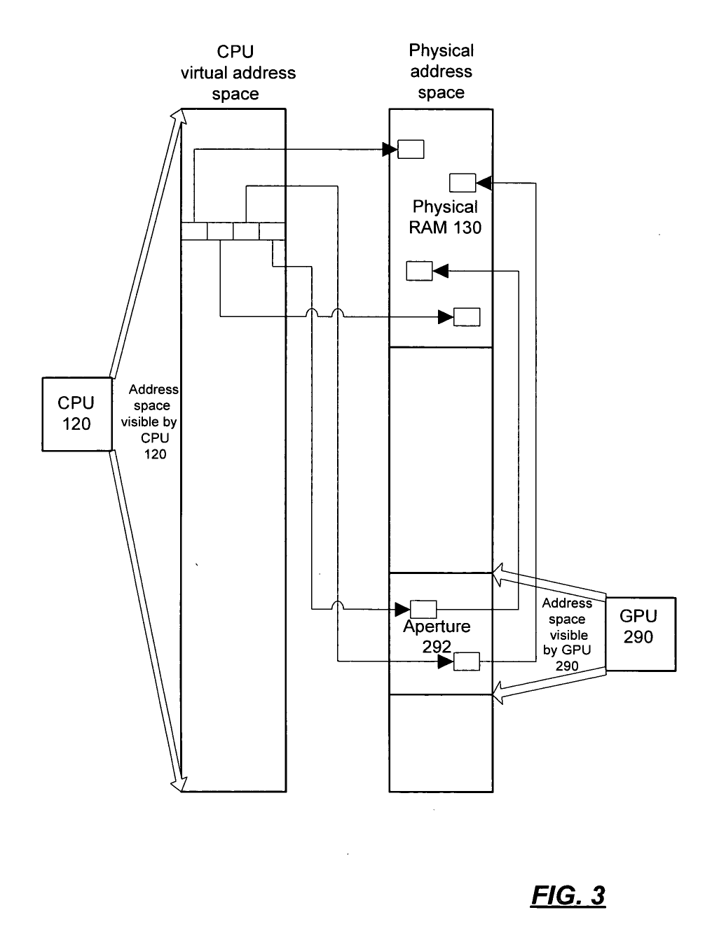

FIG. 3 illustrates the relationship between aperture 292, GPU 290, and CPU 120. As shown in FIG. 3, CPU 120 has a corresponding virtual address space that is visible (accessible) by CPU 120. The virtual address space does not contain the final data requested by CPU 120, but contains a mapping from the virtual address to some physical address. The physical address space includes system memory 130, I/O addresses associated with PCI controller 240 and chipset 250, aperture 292 addresses that map to system memory 130, and the like. The physical address space illustrated in FIG. 3 includes system memory 130 and aperture 292. GPU 290 can address aperture 292, and thus aperture 292 is visible to GPU 290. As shown in FIG. 3, aperture 292 maps to system memory 130. That is, aperture 292 does not contain the actual graphics data but contains the address mappings indicating where the actual graphics resides in system memory 130.

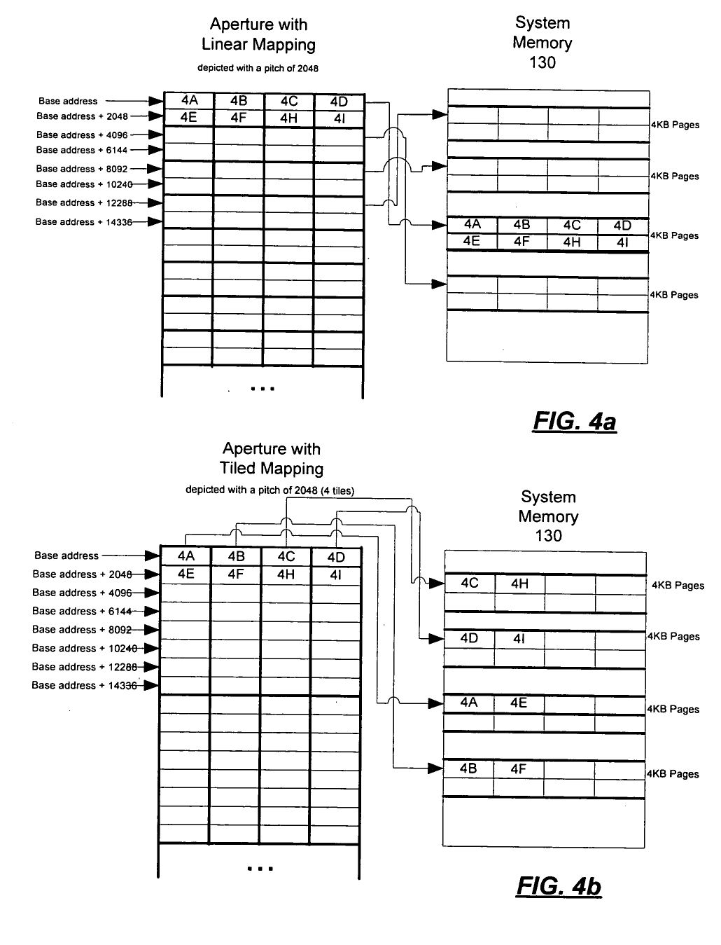

As shown in FIG. 3, CPU 120 can access system memory 130 either directly or via aperture 292. When graphics data is evicted from the aperture mapping to system memory 130 (with no aperture mapping), CPU 120 can no longer view the graphics data in a linear fashion. Instead, CPU 120 sees the graphics data arranged in a discontiguous fashion. This is illustrated in more detail in FIGS. 4a and 4b.

As can be seen in FIG. 4a, which illustrates linear aperture mapping, system memory 130 contains a contiguous set of graphics data (4A-4I). Aperture 292 contains a mapping that references or maps to graphics data (4A-4I) in the same contiguous fashion as the actual graphics data itself. That is, the mappings in aperture 292 are in the same order as the actual graphics data in system memory 130. In linear mapping, pages (typically 4 Kb size but possibly other sizes) are mapped between aperture 292 and system memory 130.

In FIG. 4b, which illustrates a tiled aperture mapping, system memory 130 contains a discontiguous set of graphics data (4A-4I) and aperture 292 contains a mapping that references or maps to graphics data (4A-4I). As shown, the mappings to data 4A-4I in aperture 292 are contiguous while the actual graphics data in system memory 130 are discontiguous. The mappings in aperture 292 allow CPU 120 to view system memory 130 in a contiguous or linear fashion. While CPU 120 can access system memory 130 through non-local graphics aperture 292 to get a linear view, when graphics data is evicted to system memory 130 (unmapped from aperture 292), only the discontiguous view of system memory 130 remains. In tiled mapping, aperture 292 has a pitch (or width) and each pitch may be divided into tiles. Each tile of aperture 292 is mapped to system memory 130 and may be mapped to a section of system memory 130 that is not the beginning of a page of system memory 130.

While FIGS. 4a and 4b show a single aperture 292 implementing linear mapping and a single aperture 292 implementing tiled mapping, respectively, aperture 292 may be divided into segments. Each segment of aperture 292 can be independently implemented with either a linear mapping or a tiled mapping. Each tiled segment may have its own predefined pitch (e.g., 512, 1024, 2048, 4096, 8092 bytes, and the like) and tile size (e.g., 128 bytes by 32 rows, 512 bytes by 8 rows, and the like). The discontiguous nature of tiled mapping may be handled differently depending on whether an allocation is a static video allocation or a dynamic video allocation, as described in more detail below.

Static Allocations of Video Data

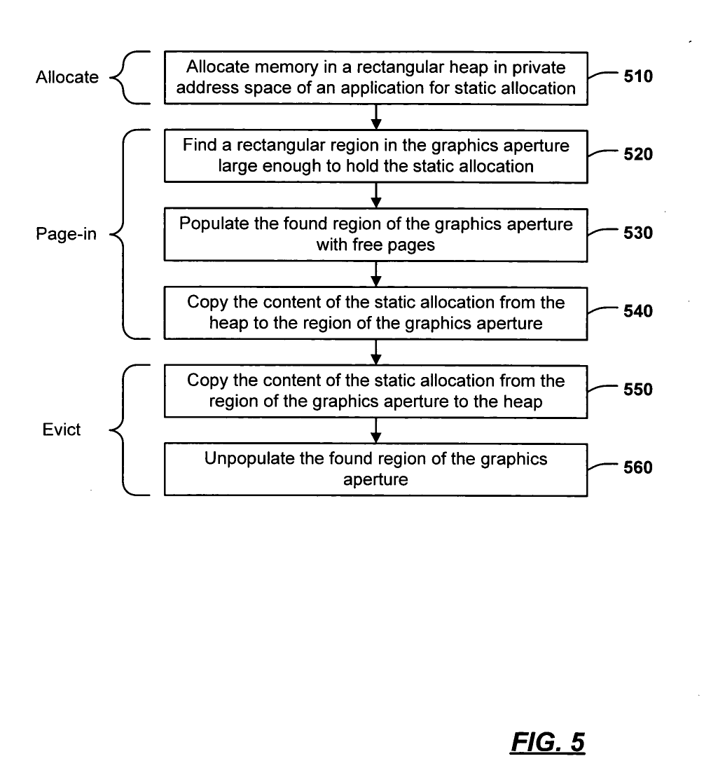

FIG. 5 is a flow diagram showing an illustrative method for managing static allocations of video data in an aperture that maps data in a tiled fashion, in accordance with an embodiment of the invention. In one embodiment, at boot time or startup time, video memory manager 200 allocates some of system memory 130 and populates the GPU aperture 292 with free pages, thereby reserving such pages for storage of static allocations of video data. At this point, GPU aperture 292 is treated like regular dedicated video memory. In other words, the pages used to populate GPU aperture 292 are used like dedicated video memory until the computer system 110 is rebooted. In this embodiment, memory for storing a static allocation of video data may be allocated in the private address space of application 135. When video data is desired by GPU 290, that video data is copied into the previously reserved pages.

While video memory manager 200 may allocate all of the memory at startup time, in another embodiment, video memory manage 200 allocates and populates system memory 130 on the fly as aperture range is desired. To page-in video data, static allocations of video data are copied from one page location (in application 135) to another page location (mapped via aperture 292).

Video memory manager 200 may allocate a rectangular heap for containing the static allocations of video data in the private address space of each application 135 and may manage each heap independently of the others. The rectangular heap typically has the same pitch as aperture 292, but may be a different size and may grow as appropriate. Video memory manager 200 doesn't need to know the size of the tiles of aperture 292. Also, video memory manager 200 doesn't need to know the tile to page mapping for the memory heap since the memory heap is independent of aperture 292 (since video data is copied between them).

Pages in the heap are typically kept in the reserved state when there's no allocation. When an allocation is made, the underlying pages are typically committed up front (to provide a location for eviction) but are typically kept in a demand zero state so that the memory manager of operating system 134 doesn't have to copy the content back to the page file to reclaim the physical page. Because the pages in the heap aren't shared with other applications, video memory manager 200 may pack allocations in the heap tightly. Video memory manager 200 doesn't have to expand allocations to a tile boundary. Once video memory manager 200 allocates a range in aperture 292 and allocates physical pages for that range, video memory manager 200 may notify driver 210 with the location of the allocation and physical page address so that driver 210 can setup aperture 292 accordingly.

Because CPU 120 does not have a virtual address referencing aperture 292 directly and because the physical pages used by aperture 292 (e.g., a graphic translation table (gtt) of a GPU) are different than the pages allocated in the private address space of application 135, the pages used by aperture 292 may be shared among multiple applications 135. Thus, video memory manager 200 may pack video data in aperture 292 tightly. Because tiles in aperture 292 are shared between applications, direct memory access (dma) streams are typically validated manually, described in more detail below.

FIG. 5. is a flow diagram illustrating a method for video memory management. While the flow diagram (as well as subsequent flow diagrams) shows consecutive steps, such steps may be executed in various orders depending on the processing of video memory manager. For example, in connection with FIG. 5, to allocate memory, video memory manager 200 may execute step 510; to page-in video data to a region of memory accessible by GPU 290, video memory manager 200 may execute steps 520, 530, and 540; to evict video data from a region of memory accessible by GPU 290, video memory manager 200 may execute steps 550 and 560. For dynamic allocations, video memory manager 200 may execute certain steps in response to an application's request to lock or unlock a memory address corresponding to video data.

As shown in FIG. 5, to allocate memory, video memory manager executes step 510. At step 510, video memory manager 200 allocates memory in a rectangular heap in an application private address range in an application 135 for storing a static allocation of video data.

To page-in video data, video memory manager executes steps 520, 530, and 540. At step 520, video memory manager 200 finds a region in the address range of aperture 292 large enough to store the static allocation of video data. At step 530, video memory manager 200 populates the found region with free pages. At step 540, video memory manager copies the static allocation of video data from the rectangular heap to the address range of graphics processing unit aperture 292.

To evict video data, video memory manager executes steps 550 and 560. At step 550, video memory manager 200, copies the static allocation of video data from address range of graphics processing unit aperture 292 to the rectangular heap. At step 560, video memory manager 200 unpopulates the found region of graphics processing unit aperture 292.

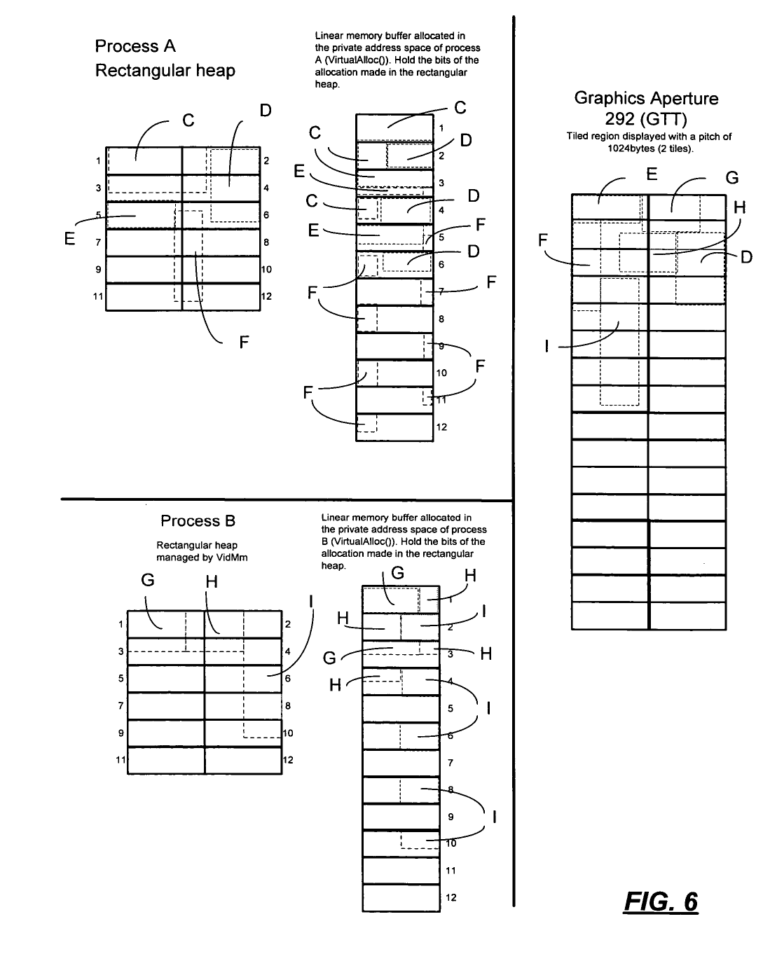

FIG. 6 is a block diagram showing an illustrative mapping resulting from the illustrative method of FIG. 5. As shown in FIG. 6, static allocations of video data may be stored in a rectangular heap of a first application 135 (shown as Process A) and rectangular heap of a second application 135 (shown as Process B). As shown, the static allocations of video data may be tightly packed in each rectangular heap. Also as shown, tiles of aperture 292 may share data from multiple applications 135.

In another embodiment, aperture 292 is mapped over pages holding video data. Because the aperture pages are actually regular system memory pages that are mapped to aperture 292, it makes sense to reuse them instead of transferring content back and forth. In this embodiment, video memory manager 200 allocates a rectangular heap in the private address space of each application and manages it independently of all other applications. The rectangular heap has the same pitch as the aperture 292. Also, video memory manager 200 can access information about the tile size of aperture 292 and the tile to page mapping between system memory 130 and aperture 292. With such information, video memory manager 200 may determine the pages that are spanned by an allocation of video data and lock those pages when the allocation is to be visible through aperture 292.

The pages in the rectangular heap are typically kept in the reserved state when there's no allocation of video data spanning the pages. When an allocation is allocated, the pages are typically committed up front, but not locked until the allocation is requested by GPU 290. At this time, video memory manager 200 builds a memory description list (MDL) and provides the MDL to driver 210 to map it through aperture 292 at a location determined by video memory manager 200. An MDL describes the list of physical pages used by a given virtual address.

Since the pages used by aperture 292 come from the heap in the private address space of an application, applications can't inherently share a tile within aperture 292 because one tile refers to one page and those pages are only visible to one process. Therefore, allocations from different processes are expanded to the entire tile.

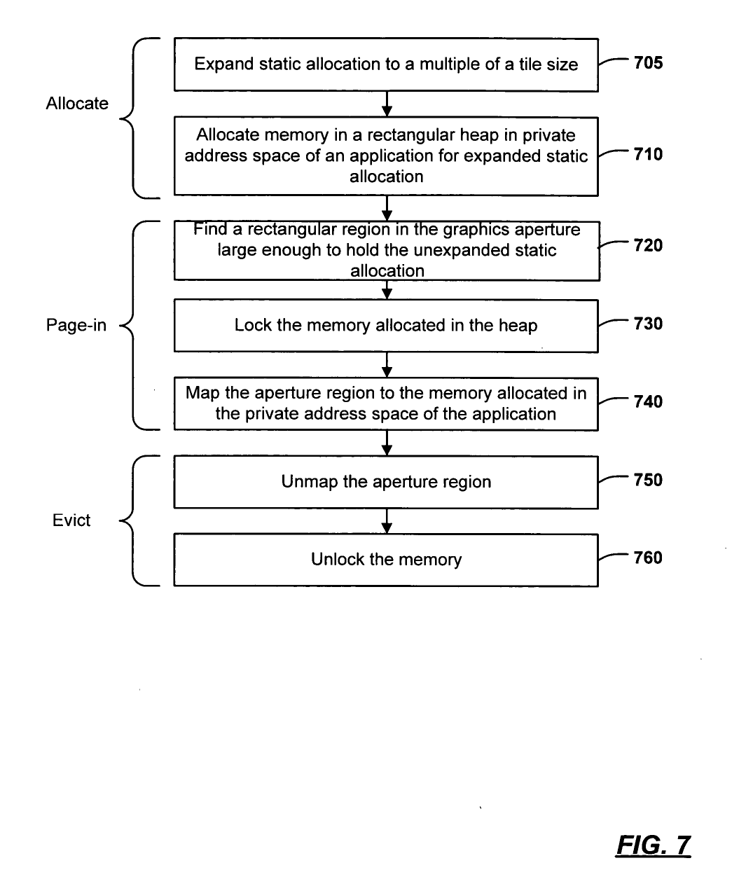

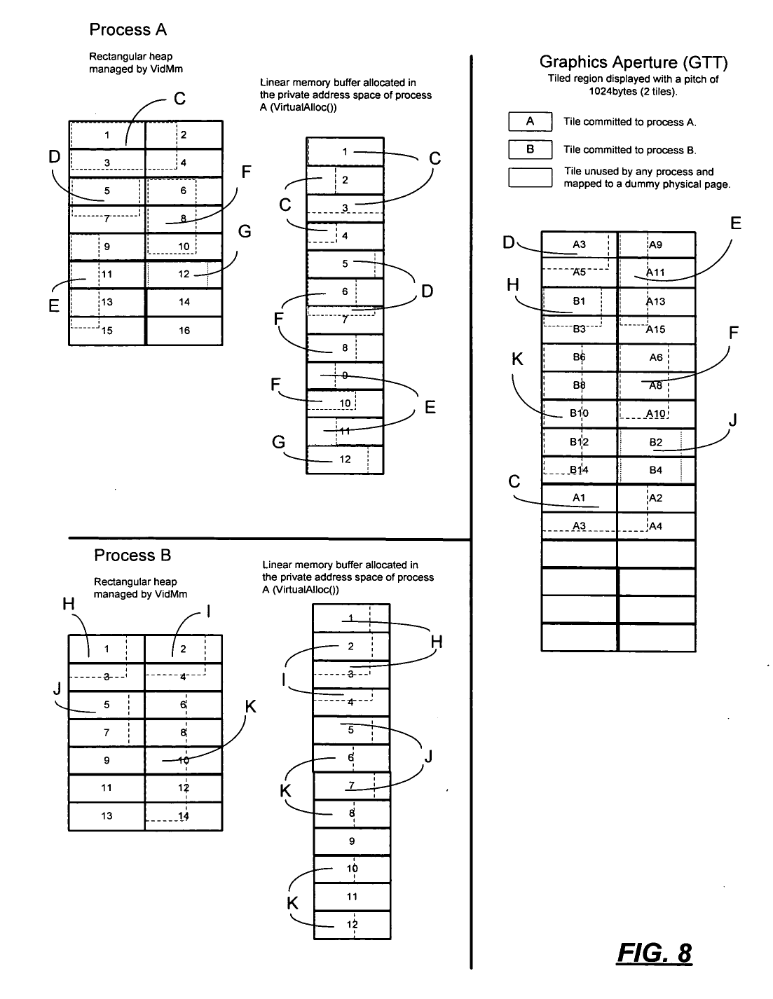

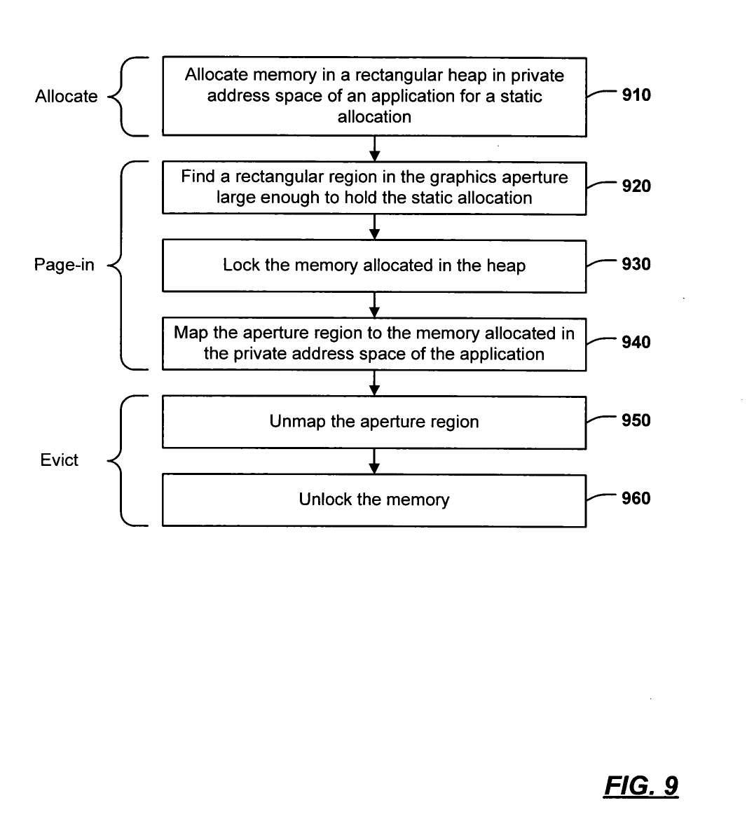

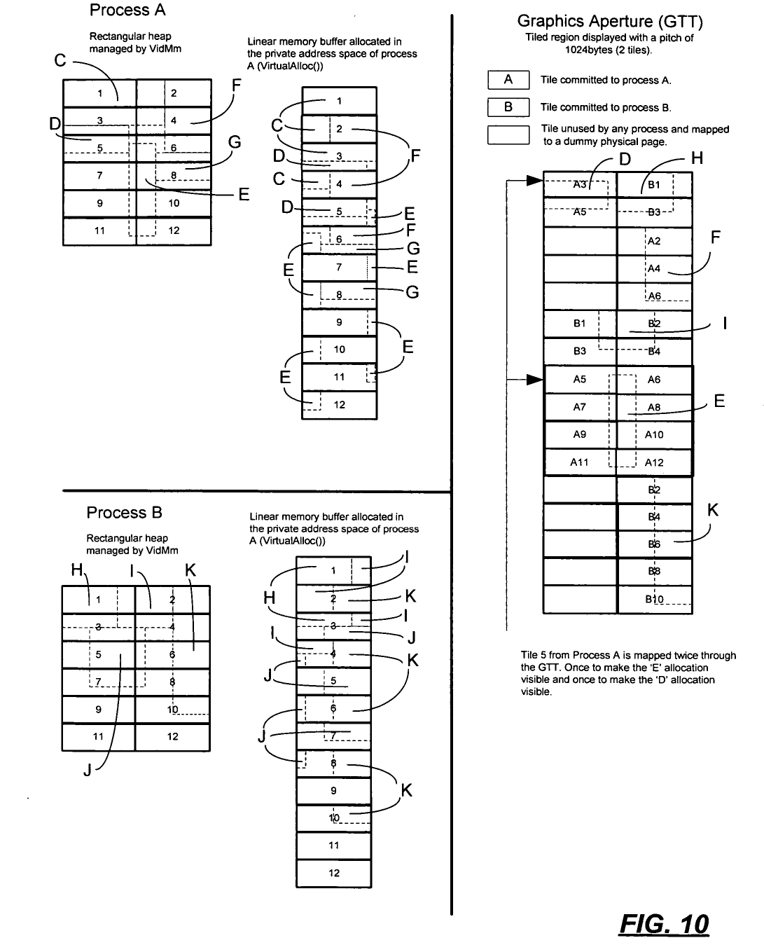

A concern may arise when multiple allocations from one application should be in “video” memory at the same time. In one embodiment, each allocation is expanded in the rectangular heap to an entire tile and each page of the rectangular heap is mapped into a single tile of aperture 292, as illustrated in FIGS. 7 and 8. In another embodiment, allocations are tightly packed in the rectangular heap and each page of the rectangular is mapped to multiple different tiles of aperture 292 if more than one allocation shares a single tile in the rectangular heap, as illustrated in FIGS. 9 and 10.

Video memory manager 200 may also bring in some allocations into aperture 292 at the same relative location (horizontal tile position) where the allocation resides in the system memory heap, otherwise the allocation may be moved around in “video” memory during paging. Small surfaces could be packed in a single allocation that is moved in and out of aperture 292 as a single entity. Because tiles in aperture 292 aren't shared between applications, video memory manager 200 could use a different video aperture per application to validate GPU memory accesses instead of parsing the DMA stream.

As shown in FIG. 7, to allocate memory, video memory manager 200 executes steps 705 and 710. At step 705, video memory manager 200 expands a static allocation of video data to a multiple of a tile size of graphics processing unit aperture 292. At step 710, video memory manager 200 allocates memory in a rectangular heap in an application private address range for storing the expanded static allocation of video data.

To page-in video data, video memory manager executes steps 720, 730, and 740. At step 720, video memory manager 200 finds a region in the address range of graphics processing unit aperture 292 large enough to store the unexpanded static allocation of video data. At step 730, video memory manager 200 locks the memory allocated in the rectangular heap. At step 740, video memory manager 200 maps the found region in the address range of graphics processing unit aperture 292 to the memory allocated in the rectangular heap.

To evict video data, video memory manager executes steps 750 and 760. At step 750, video memory manager 200 unmaps the found region in the address range of graphics processing unit aperture 292 from the memory allocated in the rectangular heap. At step 760, video memory manager 200 unlocks the memory allocated in the rectangular heap.

FIG. 8 is a block diagram showing an illustrative mapping resulting from the illustrative method of FIG. 7. As shown in FIG. 8, static allocations of video data may be stored in a rectangular heap of a first application 135 (shown as Process A) and rectangular heap of a second application 135 (shown as Process B). As shown, the static allocations of video data are expanded to a multiple of a tile size. Also as shown, tiles of aperture 292 do not share data from multiple applications 135. Because tiles in aperture 292 aren't shared between applications, video memory manager 200 could use a different video aperture per application to validate GPU memory accesses instead of parsing the DMA stream.

As shown in FIG. 9, to allocate memory, video memory manager executes step 910. At step 910, video memory manager 200 allocates memory in a rectangular heap in an application private address range for storing a static allocation of video data.

To page-in video data, video memory manager executes steps 920, 930, and 940. At step 920, video memory manager 200 finds a region in the address range of graphics processing unit aperture 292 large enough to store the static allocation of video data. At step 930, video memory manager 200 locks the memory allocated in the rectangular heap. At step 940, video memory manager 200 maps the found region in the address range of graphics processing unit aperture 292 to the memory allocated in the rectangular heap.

To evict video data, video memory manager executes steps 950 and 960. At step 950, video memory manager 200 unmaps the found region in the address range of graphics processing unit aperture 292 from the memory allocated in the rectangular heap. At step 950, video memory manager 200 unlocks the memory allocated in the rectangular heap.

FIG. 10 is a block diagram showing an illustrative mapping resulting from the illustrative method of FIG. 9. As shown in FIG. 10, static allocations of video data may be stored in a rectangular heap of a first application 135 (shown as Process A) and rectangular heap of a second application 135 (shown as Process B). As shown, the static allocations of video data may be tightly packed in each rectangular heap. Also as shown, tiles of aperture 292 do not share data from multiple applications 135. Further, as shown, some pages of aperture 292 may be mapped multiple times, e.g., once for each application.

Dynamic Allocations of Video Data

For dynamic allocations, an application 135 can request access to a surface for direct access by CPU 120. As described above, CPU 120 may get a linear view of the surface through aperture 292 (and mapping directly to system memory 130 would typically result in a discontiguous view). Unmapping an allocation from aperture 292 could mean that CPU 120 loses the ability to view the surfaces contiguously.

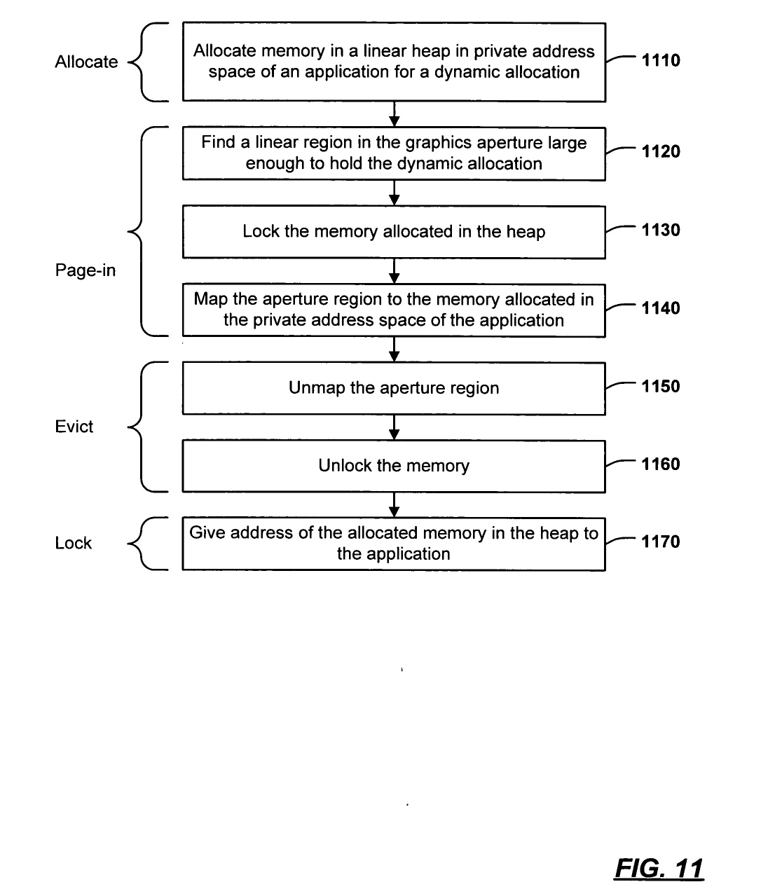

In one embodiment, such as shown in FIG. 11, dynamic allocations are only made in the linear segment of aperture 292. Thus, dynamic allocations can be allocated linearly out of a heap in the private address space of the creating application and mapped through the linear segment of aperture 292 for GPU 290 to access them. The paging can be performed by manipulating the graphics aperture rather than by transferring content from one memory location to another memory location. Also, aperture 292 may be modified on a per application basis to allow hardware validation of memory access. For this embodiment, GPU 290 should provide a mechanism to maintain coherency between CPU 120's view of a page (through the page table directly to physical system memory 130) and GPU 290's view of a page (through non-local aperture 290 to the physical system memory 130). For example, CPU 120 and GPU 290 may snoop each's other to determine if the other has more up to date data for a particular address.

As shown in FIG. 11, to allocate memory, video memory manager executes step 1110. At step 1110, video memory manager 200 allocates memory in a linear heap in an application private address range for storing a dynamic allocation of video data.

To page-in video data, video memory manager executes steps 1120, 1130, and 1140. At step 1120, video memory manager 200 finds a linear region in the address range of graphics processing unit aperture 292 large enough to store the dynamic allocation of video data. At step 1130, video memory manager 200 locks the memory allocated in the linear heap. At step 1140, video memory manager 200 maps the found region in the address range of graphics processing unit aperture 292 to the memory allocated in the linear heap.

To evict video data, video memory manager executes steps 1150 and 1160. At step 1150, video memory manager 200 unmaps the found region in the address range of graphics processing unit aperture 292 from the memory allocated in the linear heap. At step 1160, video memory manager 200 unlocks the memory allocated in the linear heap.

Upon a request from an application for access to a dynamic allocation of video data, video memory manager executes step 1170. At step 1170, video memory manager 200 gives the address of the memory allocated in the linear heap to the application.

In another embodiment, video memory manager 200 aliases an allocation for a Direct X lock operation so an application 135 doesn't have to access the allocation through aperture 292. In this embodiment, video memory manager 200 associates each dynamic allocation with a virtual address range in the private address space of the creating application. The virtual address range holds the content of the allocation in a discontiguous format, but is not made visible to application 135. Instead, the virtual address range is used only to hold the content of an evicted allocation.

When application 135 requests a lock operation on a dynamic allocation, video memory manager 200 allocates a new system memory buffer in the private address space of the application and requests driver 210 to transfer the content of the allocation from the tiled range to the newly allocated system memory buffer. Driver 210 un-tiles the surface during the transfer to linearize the content as seen by CPU 120 in the system memory buffer. On an unlock operation, video memory manager 200 requests driver 210 to transfer (and re-tile) the content of the system memory buffer back to the tiled segment in aperture 292. Video memory manager 200 then frees the allocated system memory buffer. Alternatively, video memory manager 200 may allocate one or several such buffers up front (e.g., one for each dynamic allocation) and manage the transfer of content in and out of the buffers. Video memory manager 200 may keep the allocated buffers in the demand-zero state as to not use page-file resources.

In this embodiment, aperture 292 may modified on a per application basis to allow hardware validation of memory access. Allocations in aperture 292 are expanded to fit an entire tile. The unused memory of a tile can be reused by an allocation from the same application.

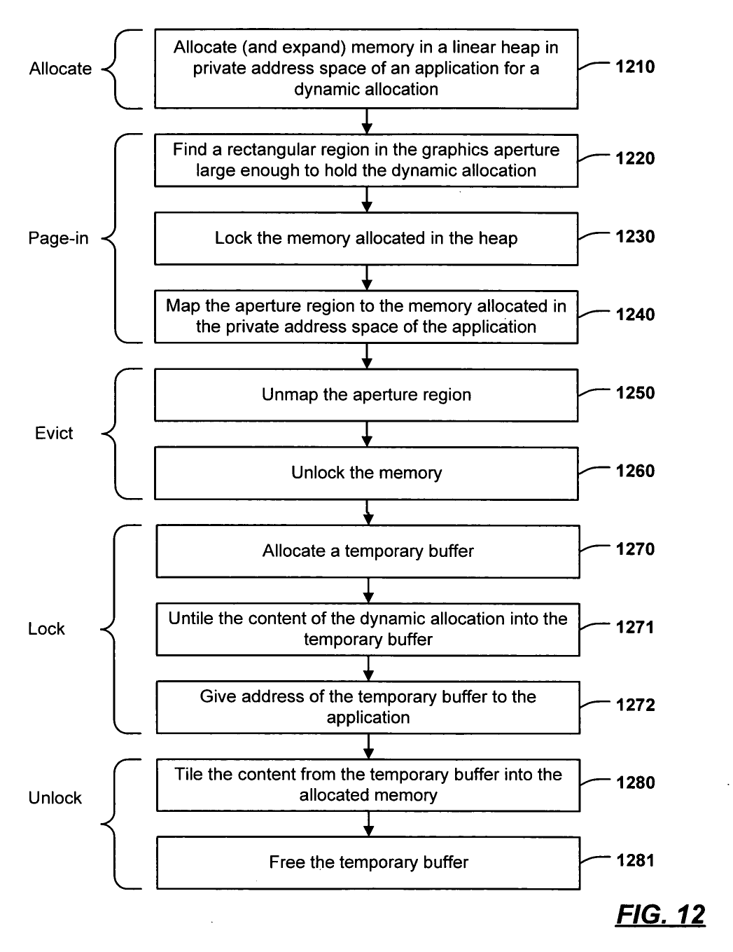

As shown in FIG. 12, to allocate memory, video memory manager executes step 1210. At step 1210, video memory manager 200 expands and allocates memory in a linear heap in an application private address range for storing a dynamic allocation of video data.

To page-in video data, video memory manager executes steps 1220, 1230, and 1240. At step 1220, video memory manager 200 finds a rectangular region in the address range of graphics processing unit aperture 292 large enough to store the dynamic allocation of video data. At step 1230, video memory manager 200 locks the memory allocated in the linear heap. At step 1240, video memory manager 200 maps the found region in the address range of graphics processing unit aperture 292 to the memory allocated in the linear heap.

To evict video data, video memory manager executes steps 1250 and 1260. At step 1250, video memory manager 200 unmaps the found region in the address range of graphics processing unit aperture 292 from the memory allocated in the linear heap. At step 1260, video memory manager 200 unlocks the memory allocated in the linear heap.

Upon a request from an application for access to a dynamic allocation of video data, video memory manager executes step 1270, 1271, and 1272. At step 1270, video memory manager 200 allocates a temporary buffer. At step 1271, video memory manager 200 untiles the dynamic allocation of video data from the memory allocated in the linear heap into the temporary buffer. At step 1272, video memory manager 200 gives the address of the temporary buffer to the application.

When the application is finished with a dynamic allocation of video data, video memory manager executes step 1280 and 1281. At step 1280, video memory manager 200 tiles the dynamic allocation of video data from the temporary buffer into the memory allocated in the linear heap. At step 1281, video memory manager 200 frees the temporary buffer.

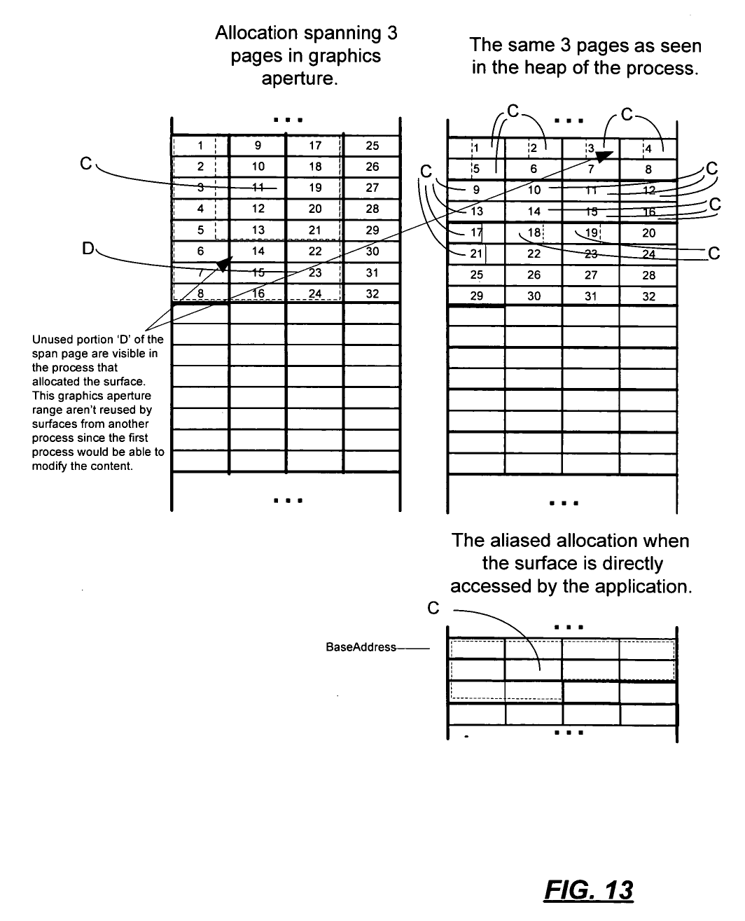

FIG. 13 shows the same memory as seen through aperture 292 versus seen directly without going through aperture 292. The aperture 292 effectively un-tiles the allocation on the fly so the allocation appears linear. However, bypassing aperture 292, the data of the allocation may appear scattered about.

In another embodiment, video memory manager 200 distinguishes between system memory 130 and “video” memory (mapped to system memory 130 through aperture 292). When an allocation is evicted from “video” memory, video memory manager 200 actually transfers the content to system memory 130. Video memory manager 200 also un-tiles the content along with transferring the content. In this embodiment, video memory manager 200 allocates a rectangular heap in the private address space of the creating application. The heap has the same pitch as aperture 292. When the allocation is in “video” memory, video memory manager 200 typically doesn't hold the system memory pages. page table entries are typically put back in the reserved or demand zero state. To page in a surface, video memory manager 200 allocates an address space in aperture 292 and physical pages in system memory 130. Video memory manager 200 copies the content from system memory 130 to the physical pages in system memory 130 that are mapped to the address space in aperture 292.

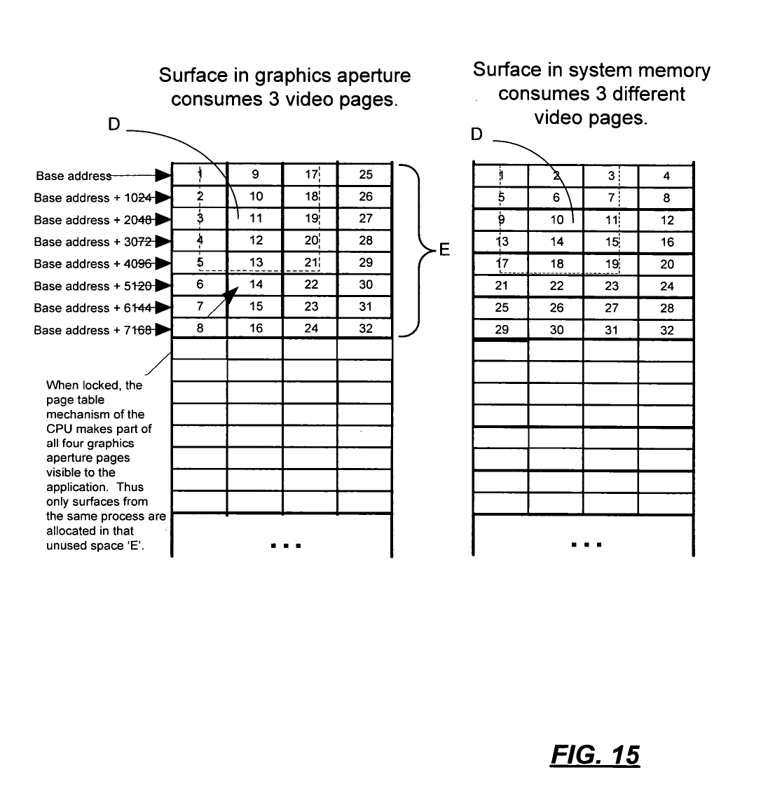

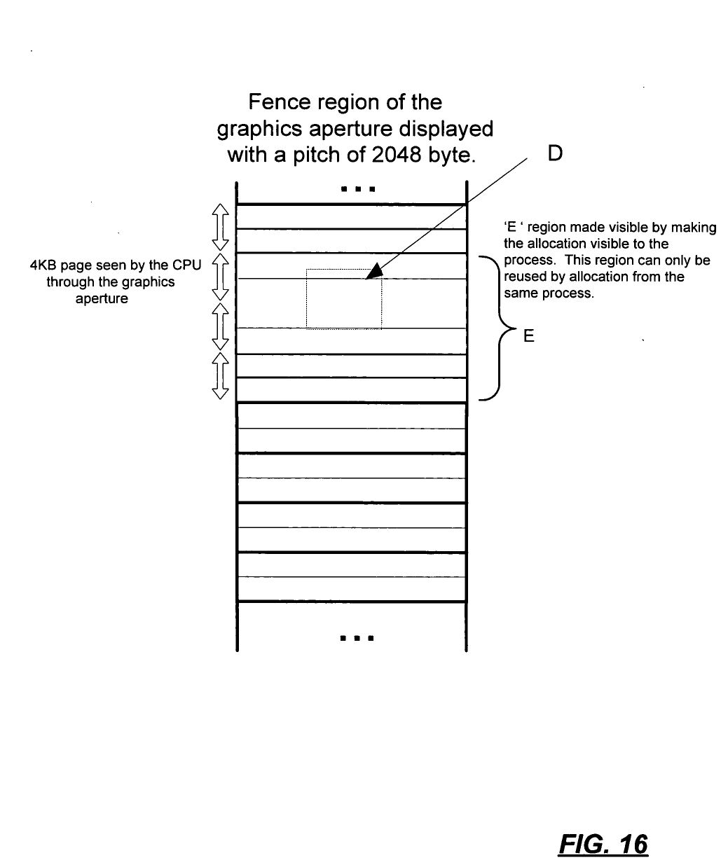

FIG. 15 shows what would be visible to CPU 120 if an allocation is mapped through the rectangular graphics aperture 292. Even if a surface doesn't span the entire width of the allocated rectangle, the entire width of the graphics aperture is visible to CPU 120. Thus, the tiles to the left or right of an allocation are typically not shared by a different process, even though those tile aren't used. FIG. 16 shows a fence region around an allocation to protect from access by other applications.

In this embodiment, video memory manager 200 expands each allocation to the pitch of the aperture 292 (because CPU 120 may be mapped directly aperture 292). The allocation may span multiple lines if the pitch of the aperture 292 is smaller than the page size of CPU 120. The unused space to the left and right of the allocation can be used by the same application for other allocations, but is typically not used by other applications. Similarly, the height of the allocation may be expanded to start and end on rows within the same graphics page, as depicted in FIG. 10.

For non-local apertures having a pitch of 512 and 8 rows per page, an allocation is typically expanded to of width of 512 and to a height that is a multiple of 8. For non-local apertures having a pitch of 1024 and 4 rows per page, an allocation is typically expanded to of width of 1024 and to a height that is a multiple of 4. For non-local apertures having a pitch of 2048 and 2 rows per page, an allocation is typically expanded to of width of 2048 and to a height that is a multiple of 2. For non-local apertures having a pitch of 4096 and 1 row per page, an allocation is typically not expanded. For non-local apertures having a pitch of 8092 and ½ row per page, an allocation is typically expanded to of width of 512 and a height that is a multiple of 8.

In this embodiment, the entire content of an allocation is transferred from one location to another. The dynamic allocations remain tiled rather when located in aperture 292. When evicted, the allocations are untiled. CPU 120 can access the content of the allocation either through a) the graphics aperture 292 (the graphics aperture doing the un-tile operation on the fly as the GPU accessed memory); or b) directly to system memory when the content of the allocation is evicted (in which case the content is untiled during the eviction process). Allocations can be accessed by CPU 120 through aperture 292. Because a single aperture is used for all GPU processes, the DMA stream may be inspected manually by driver 210 to check for invalid memory accesses by an application 135.

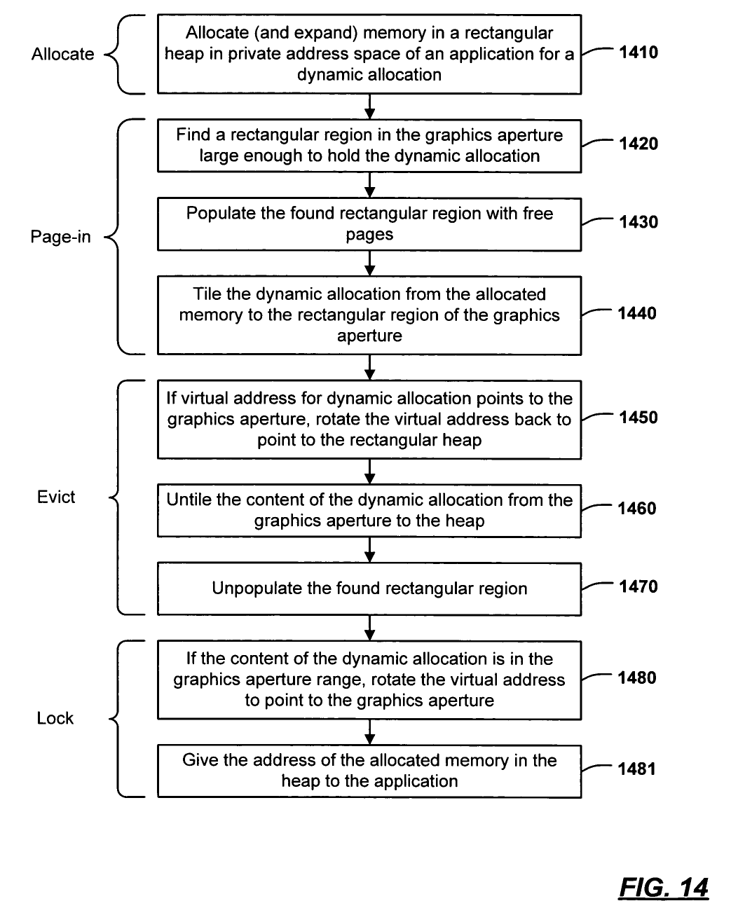

As shown in FIG. 14, to allocate memory, video memory manager executes step 1410. At step 1410, video memory manager 200 expands and allocates memory in a rectangular heap in an application private address range for storing a dynamic allocation of video data.

To page-in video data, video memory manager executes steps 1420, 1430, and 1440. At step 1420, video memory manager 200 finds a rectangular region in the address range of graphics processing unit aperture 292 large enough to store the dynamic allocation of video data. At step 1430, video memory manager 200 populates the found region with free pages. At step 1440, video memory manager 200 tiles (i.e., copies and tiles) the dynamic allocation of video data from the memory allocated in the rectangular heap to the found address range of graphics processing unit aperture 292.

To evict video data, video memory manager executes steps 1450, 1460, and 1470. At step 1450, video memory manager 200 rotates a virtual address for the dynamic allocation of video data from the found address range of graphics processing unit aperture 292 to the memory allocated in the rectangular heap, if the virtual address currently points to the found address range of graphics processing unit aperture 292. At step 1460, video memory manager 200 untiles (i.e., copies and untiles) the dynamic allocation of video data from the found address range of graphics processing unit aperture 292 to the memory allocated in the rectangular heap. At step 1470, video memory manager 200 unpopulates the found region of graphics processing unit aperture 292.

Upon a request from an application for access to a dynamic allocation of video data, video memory manager executes step 1480 and 1481. At step 1480, video memory manager 200 rotates a virtual address for the dynamic allocation of video data from the memory allocated in the rectangular heap to the found address range of graphics processing unit aperture 292, if the virtual address currently points to the memory allocated in the rectangular heap. At step 1481, video memory manager 200 gives the address of the memory allocated in the rectangular heap to the application.

In another alternative embodiment, video memory manager 200 does not allow CPU 120 to directly access aperture 292. Because the pages of system memory 130 are independent from the pages use to hold the content when mapped through aperture 292, video memory manager 200 does not expand allocations. Thus, video memory manager 200 can pack allocations from different processes tightly. When an application requests direct CPU access to an allocation, video memory manager 200 evicts the allocation from being mapped through aperture 292 and transfers the content to system memory 130 for access by the application.

In this embodiment, dynamic allocations are tiled. Allocations made by one application can be tightly packed inside the video heap inside that process private address space and copied to aperture 292. Aperture 292 may be modified on a per application basis to allow hardware validation of memory access.

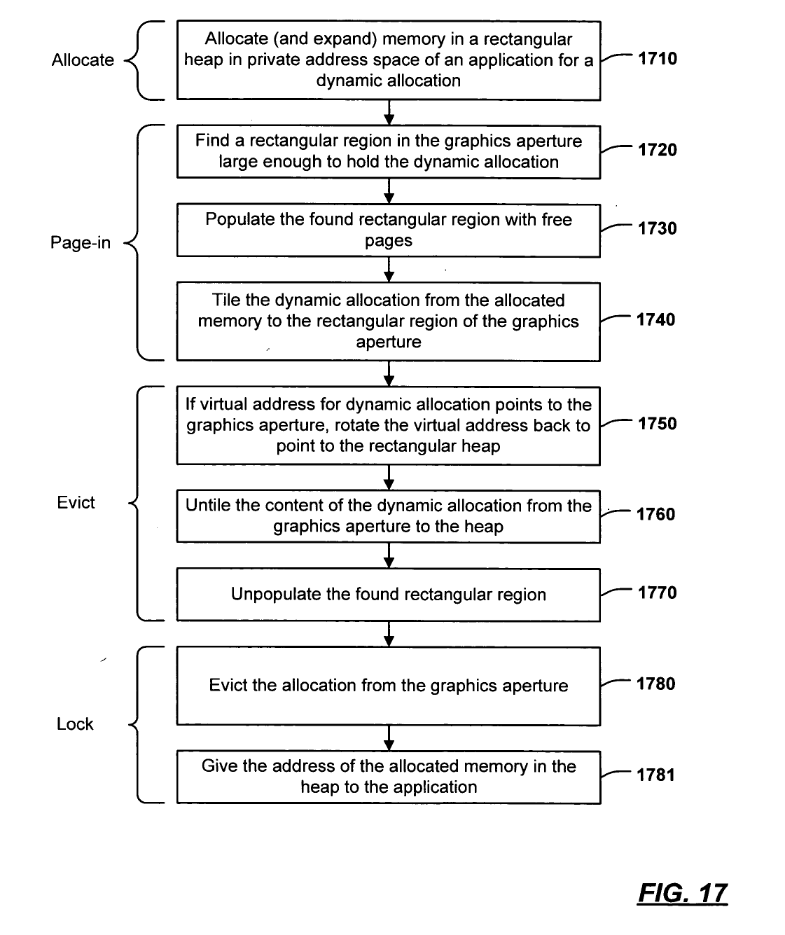

As shown in FIG. 17, to allocate memory, video memory manager executes step 1710. At step 1710, video memory manager 200 allocates memory in a rectangular heap in an application private address range for storing a dynamic allocation of video data.

To page-in video data, video memory manager executes steps 1720, 1730, and 1740. At step 1720, video memory manager 200 finds a rectangular region in the address range of graphics processing unit aperture 292 large enough to store the dynamic allocation of video data. At step 1730, video memory manager 200 populates the found region with free pages. At step 1740, video memory manager 200 tiles the dynamic allocation of video data from the memory allocated in the rectangular heap to the found address range of graphics processing unit aperture 292.

To evict video data, video memory manager executes steps 1750, 1760, and 1770. At step 1750, video memory manager 200 rotates a virtual address for the dynamic allocation of video data from the found address range of graphics processing unit aperture 292 to the memory allocated in the rectangular heap, if the virtual address currently points to the found address range of graphics processing unit aperture 292. At step 1760, video memory manager 200 untiles the dynamic allocation of video data from the found address range of graphics processing unit aperture 292 to the memory allocated in the rectangular heap. At step 1770, video memory manager 200 unpopulates the found region of graphics processing unit aperture 292.

Upon a request from an application for access to a dynamic allocation of video data, video memory manager executes step 1780 and 1781. At step 1780, video memory manager 200 evicts the dynamic allocation of video data from the found address range of graphics processing unit aperture 292. At step 1780, video memory manager 200 gives the address of the memory allocated in the rectangular heap to the application.

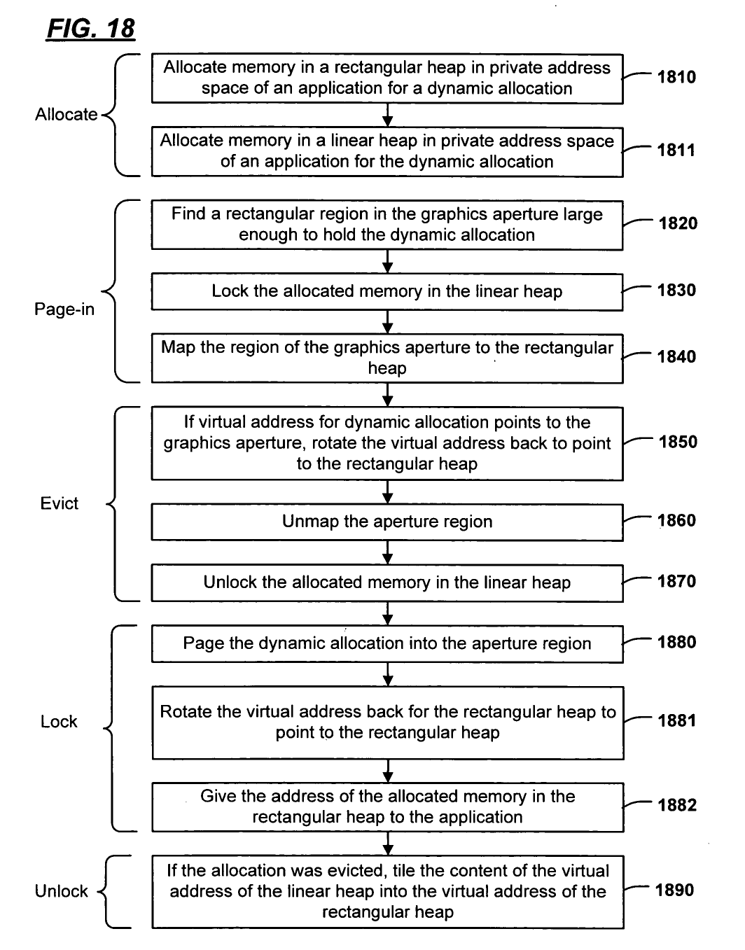

In another embodiment, depicted in FIG. 18, video memory manager 200 allows an application 135 to directly access a surface through aperture 292 with CPU 120. In this embodiment, video memory manager 200 expands allocations in the same manner as described above in connection with FIG. 17. To page allocations in and out of memory, video memory manager 200 remaps aperture 292 and does not have to transfer any video data.

In this embodiment, each dynamic allocation includes a dual video memory allocation in the private address space of the creating application. One allocation is a system memory range to hold the content of the allocation and provide a physical medium for aperture 292. When an application requests access to an allocation via CPU 120, video memory manager 200 locks the range and maps the range through aperture 292. The second allocation is a rotatable range used to temporarily hold the content of the surface when it's evicted for direct access by CPU 120.

In this embodiment, an allocation is paged into graphics aperture 292 to be accessed by an application. If the allocation is not paged in at the time of the request for direct access, video memory manager 200 can page it in and rotate the rotatable range to that location in graphics aperture 292. Alternatively, video memory manager 200 could request driver 210 to manually un-tile the allocation from its current location to the rotatable buffer.

In this embodiment, dynamic allocations are tiled. Allocations are packed very tightly in each application private address space. Because CPU 120 uses aperture 292 to access content, a single aperture is used for all GPU processes. DMA streams are inspected manually by driver 210 check for invalid memory accesses by application 135. The user mode driver may provides a routine to un-tile the allocation from the “physical medium” buffer to the rotatable buffer when the kernel mode driver is on a resolution switch. GPU hardware maintains cache coherency when a physical page is mapped and used through multiple different tiles (but non-overlapping region in each tile).

As shown in FIG. 18, to allocate memory, video memory manager executes steps 1810 and 1811. At step 1810, video memory manager 200 expands and allocates memory in a rectangular heap in an application private address range for storing a dynamic allocation of video data. At step 1811, video memory manager 200 allocates memory in a linear heap in an application private address range for storing a dynamic allocation of video data.

To page-in video data, video memory manager executes steps 1820, 1830, and 1840. At step 1820, video memory manager 200 finds a rectangular region in the address range of the graphics processing unit aperture large enough to store the dynamic allocation of video data. At step 1830, video memory manager 200 locks the memory allocated in the linear heap. At step 1840, video memory manager 200 maps the found region in the address range of graphics processing unit aperture 292 to the rectangular heap.

To evict video data, video memory manager executes steps 1850, 1860, and 1870. At step 1850, video memory manager 200 rotates a virtual address for the dynamic allocation of video data from the found address range of graphics processing unit aperture 292 to the memory allocated in the rectangular heap, if the virtual address currently points to the found address range of the graphics processing unit aperture. At step 1860, video memory manager 200 unmaps the found region in the address range of the graphics processing unit aperture from the rectangular heap. At step 1870, video memory manager 200 unlocks the memory allocated in the linear heap.

Upon a request from an application for access to a dynamic allocation of video data, video memory manager executes step 1880, 1881, and 1882. At step 1880, video memory manager 200 pages the dynamic allocation of video data into the found address range of graphics processing unit aperture 292. At step 1881, video memory manager 200 rotates a virtual address for the dynamic allocation of video data from the found address range of graphics processing unit aperture 292 to the memory allocated in the rectangular heap, if the virtual address currently points to the found address range of the graphics processing unit aperture 292. At step 1882, video memory manager 200 gives the address of the memory allocated in the rectangular heap to the application.

When the application is finished with a dynamic allocation of video data, video memory manager executes step 1890. At step 1890, video memory manager 200 tiles the dynamic allocation of video data from the memory allocated in the linear heap to the memory allocated in the linear heap, if the dynamic allocation of video data was evicted.

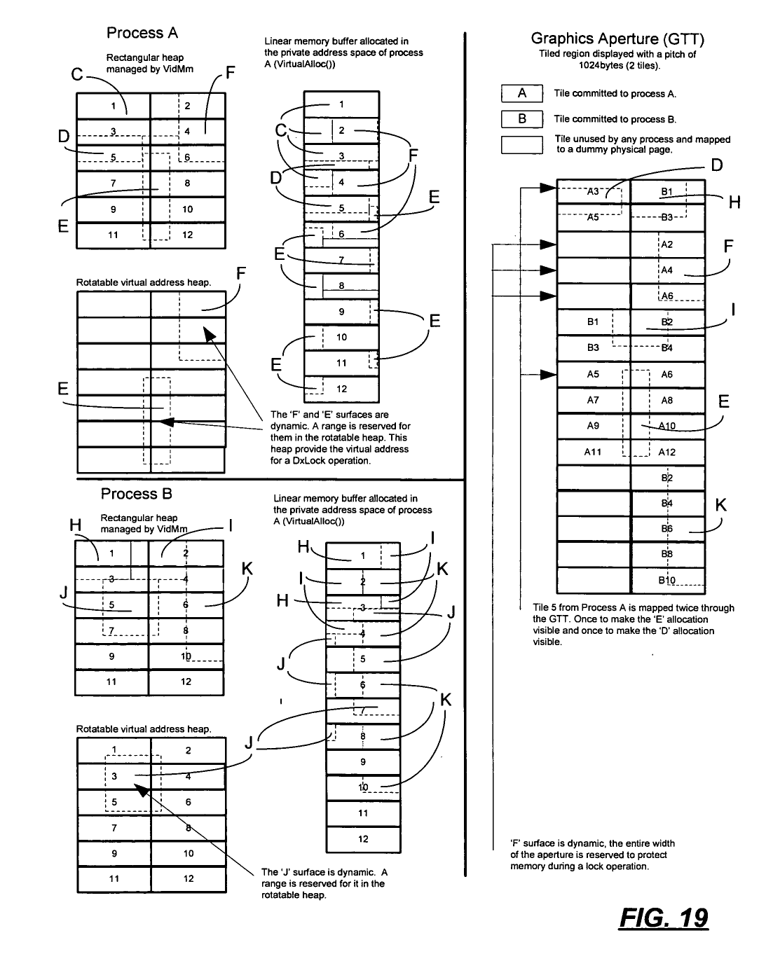

FIG. 19 is a block diagram showing an illustrative mapping resulting from the illustrative method of FIG. 18. As shown in FIG. 19, dynamic allocations of video data may be stored in a rectangular heap of a first application 135 (shown as Process A) and rectangular heap of a second application 135 (shown as Process B). As shown, the dynamic allocations of video data are tightly packed in the rectangular heap. Further, a linear heap is allocated in each of first application and second application. Further, as shown, some pages of aperture 292 may be mapped multiple times, e.g., once for each application.

Validation of DMA Stream

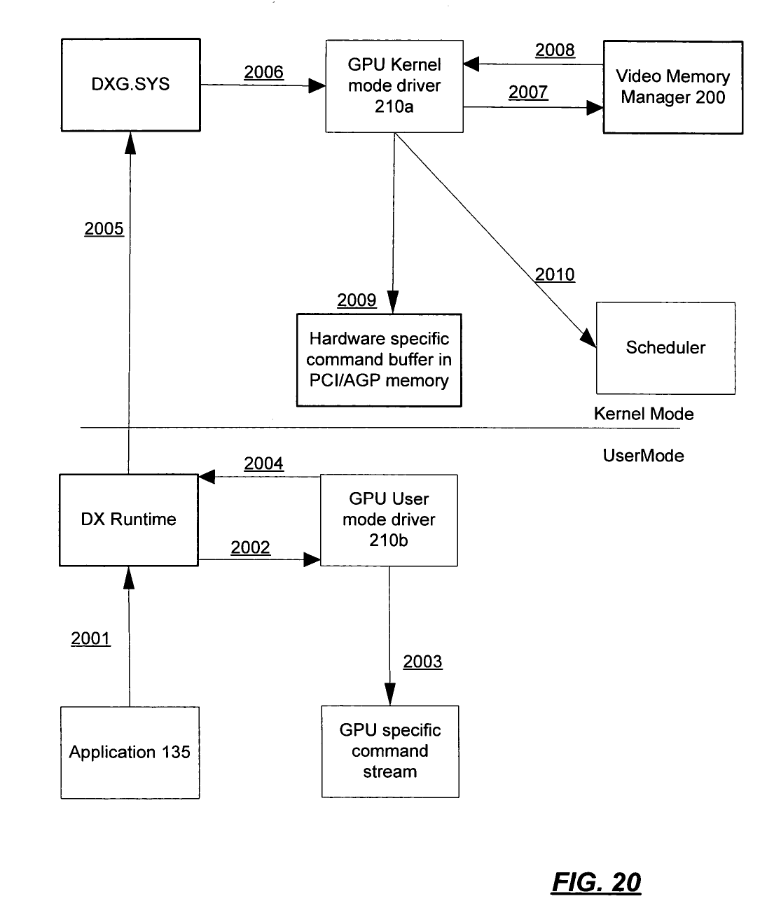

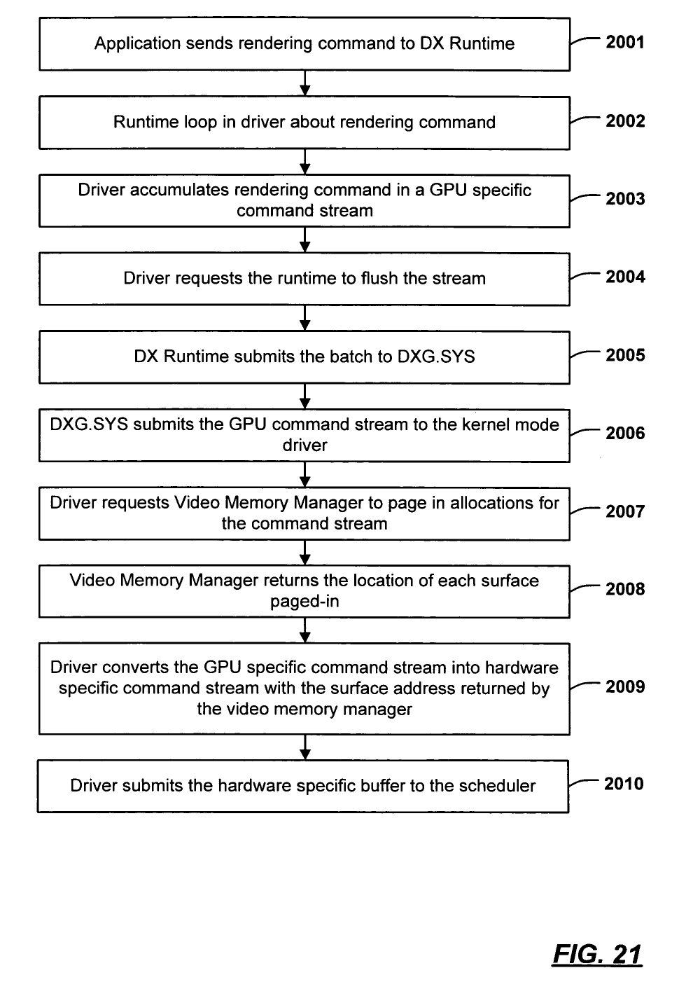

As described above, some embodiments validate the DMA stream. Such validation may be implemented in a variety of embodiments. If one graphics aperture is shared by multiple processes, the command stream built in user mode is validated by the kernel driver. The kernel mode driver validates the content of the buffer and copies the content to an alternate buffer (because the original buffer is still visible to any thread in that process). An illustrative embodiment is illustrated in FIGS. 20 and 21.

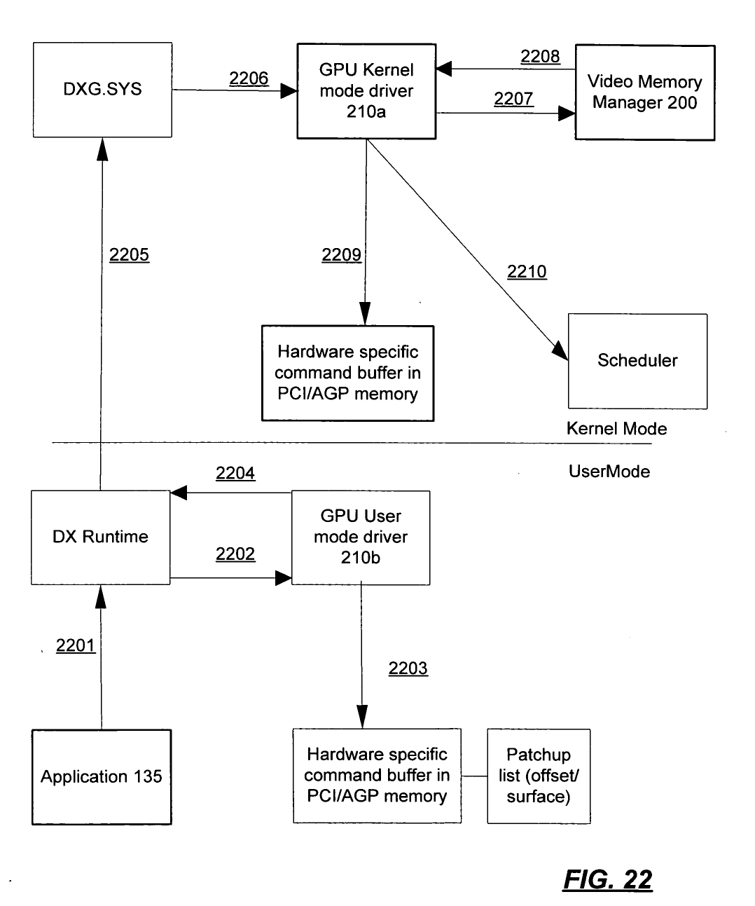

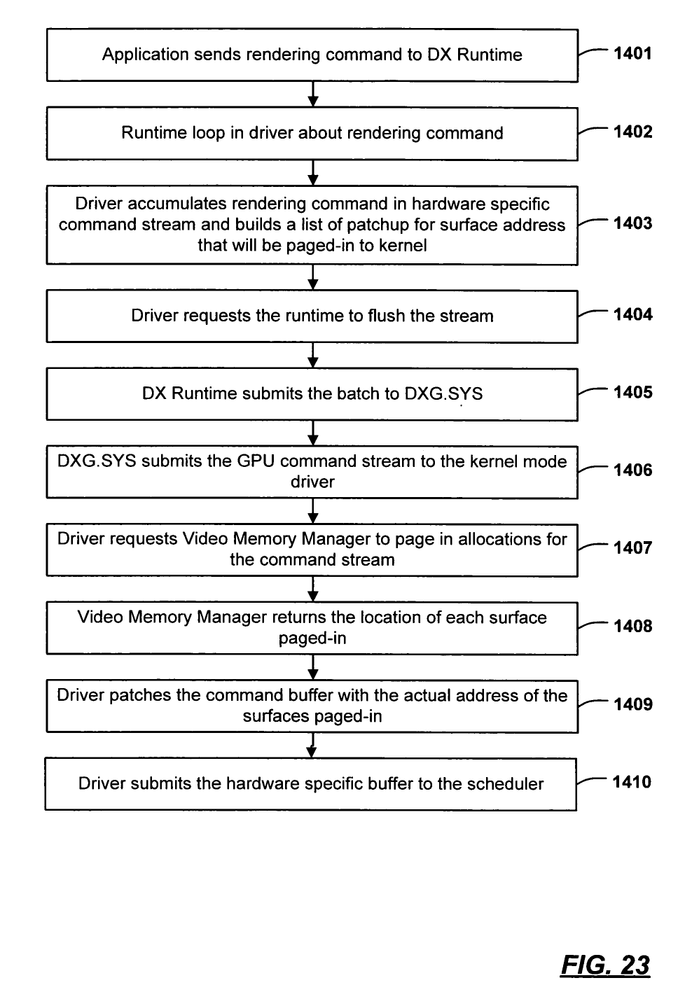

If each process has its own graphics aperture, the illustrative embodiment of FIGS. 22 and 23 15 may be used to construct and validate the hardware specific command stream. The user mode driver builds the hardware specific stream directly in user mode and builds a list of addresses to be patched once video memory manager 200 has paged in the appropriate surfaces. Memory is protected because the aperture is programmed from kernel mode.

Control of Allocation Within the Aperture

Video memory manager 200 may segment non-local 292 aperture via driver 210. Video memory manager 200 distributes the resources of a segment between various applications 135. Video memory manager manages each segment independent of the other segments, which means that an application isn't penalized in one segment because it allocations in other segments.

Segments can be configured by driver 210 to describe various video memory resources. Driver 210 may configure a segment using the following illustrative (but not exhaustive) characteristics. The base address is a PHYSICAL_ADDRESS (e.g., 64 bits) that driver 210 chooses for a segment. All allocations within the segment are addressed as an offset within the segment added to the base address. Usually a driver specifies a base address to correspond to the physical address that GPU 290 sees as the first byte of memory in the segment. In this manner, allocation addresses returned by video memory manager 200 don't have to be translated before being used by GPU 290.

For an Accelerated Graphics Port (AGP) legacy segment (VIDMM_SEGMENT_LEGACY_AGP), driver 210 doesn't know the base physical address of the AGP aperture. Thus, video memory manager 200 ignores the base address specified by driver 210 for this type of segment and instead uses the actual physical address of the segment within the AGP aperture. This allows driver 210 to use addresses generated by video memory manager 200 directly without requiring translation.

Size (SIZE_T) (e.g., 32 bits on 32 bits platform and 64 bits on 64 bits platform) specifies the size of the segment in bytes. For an AGP legacy segment, driver 210 can specify VIDMM_SEGMENT_USE_MAXIM_SIZE and video memory manager 200 attempts to allocate everything in the AGP aperture.

Pitch may be used in combination with VIDMM_SEGMENT_RECTANGULAR and specify the width of the segment when rectangular management is needed. Tile width (ULONG) may be used in combination with VIDMM_SEGMENT_TILE_BASED and specifies the width of a tile. One tile maps to a native hardware page so the tile height can be determined by video memory manager 200.

Driver can specify different flags that control how video memory manager 200 manipulates the segment. VIDMM_SEGMENT_RECTANGULAR specifies that rectangular management is used in the segment.

VIDMM_SEGMENT_APERTURE specifies that the segment is an aperture and doesn't have physical pages holding the content of bits. Video memory manager 200 allocates system memory for the bits and requests driver 210 to map the allocated pages in the aperture. When using this flag, driver 210 also specifies a non-NULL callback for the Map and Unmap function.

VIDMM_SEGMENT_LEGACY_AGP specifies that the segment is a legacy AGP segment that uses a portion of the AGP aperture exposed by the chipset. Video memory manager 200 allocates a page for the underlying aperture and communicates with a Graphics Address Relocation Table (GART) driver to map and unmap memory from the legacy aperture.

VIDMM_SEGMENT_CPU_VISIBLE specifies that the segment is visible to the CPU and that video memory manager 200 can map a CPU virtual address to the segment.

VIDMM_SEGMENT_MAP_CPU_THROUGH_APERTURE specifies whether video memory manager 200 maps the CPU virtual address through the aperture or directly through the allocated system pages. This flag may be used in conjunction with VIDMM_SEGMENT_APERTURE.

VIDMM_SEGMENT_TILE_BASED specifies how video memory manager 200 allocates pages for allocation. If this flags is specified, video memory manager 200 maps pages to tiles. If this flags isn't specified, video memory manager 200 uses linear mapping in the segment space (first PAGE_SIZE of segment is first page, second PAGE_SIZE of segment is second page, etc).

VIDMM_SEGMENT_USE_MAXIMUM_SIZE specifies that video memory manager 200 attempt to allocate the largest biggest AGP aperture possible. This flag may be used in combination with VIDMM_SEGMENT_LEGACY_AGP.

When driver 210 specifies the flag VIDMM_SEGMENT_APERTURE, it may further specify two callback functions for video memory manager 200 to call to map a specific MDL in the aperture, MapFunction and UnmapFunction.

At allocation time, driver 210 may specify which segment should be used when paging an allocation from system memory. Driver 210 may also specify whether video memory manager 200 should look for holes starting from the beginning or the end of the segment. Driver 210 may specify the segment at allocation time by specifying two DWORD values that define the preferred and supported segment. Video memory manager 200 tries to allocate a surface out of the preferred segment when possible and the supported segment otherwise.

At each second or other predefined interval, video memory manager 200 may request from driver 210 the optimal location for the most busy surfaces.

Video memory manager 200 may provide statistics about the segment to GPU 290 so that GPU 290 may make decisions on the placement of surfaces. Video memory manager 200 may provide, for example, a total amount of memory allocated to a segment (the memory might currently be evicted, but may be specified as belonging to the segment), a total amount of memory currently committed, a size of the biggest chunk available, a number of eviction in the past second for the segment, a number of eviction in the past ten seconds for the segment, a number of bytes evicted in the past one second for the segment, a number of bytes evicted in the past ten seconds for the segment, and the like.

As can be seen, the invention provides various techniques for dealing with GPUs that may map memory from a graphics aperture to system memory in a tiled fashion. Program code (i.e., instructions) for performing the above-described methods may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer, the machine becomes an apparatus for practicing the invention. The invention may also be embodied in the form of program code that is transmitted over some transmission medium, such as over electrical wiring or cabling, through fiber optics, over a network, including the Internet or an intranet, or via any other form of transmission, wherein, when the program code is received and loaded into and executed by a machine, such as a computer, the machine becomes an apparatus for practicing the above-described processes. When implemented on a general-purpose processor, the program code combines with the processor to provide an apparatus that operates analogously to specific logic circuits.

It is noted that the foregoing description has been provided merely for the purpose of explanation and is not to be construed as limiting of the invention. While the invention has been described with reference to illustrative embodiments, it is understood that the words which have been used herein are words of description and illustration, rather than words of limitation. Further, although the invention has been described herein with reference to particular structure, methods, and embodiments, the invention is not intended to be limited to the particulars disclosed herein; rather, the invention extends to all structures, methods and uses that are within the scope of the appended claims. Those skilled in the art, having the benefit of the teachings of this specification, may effect numerous modifications thereto and changes may be made without departing from the scope and spirit of the invention, as defined by the appended claims.

What is claimed:

1. A method for video memory management in a computer environment having a main processing unit for executing an operating system and an application, a system memory, and a graphics processing unit having an aperture that maps, in a tiled manner, between a portion of system memory and the graphics processing unit, the method comprising:
managing memory for video data in a heap that is in a private address space of the application;
allocating virtual memory and maintaining mappings between the allocated virtual memory, the heap, and the aperture such that both the main processing unit and the graphics processing unit can view the data in an untiled manner.

2. The method as recited in claim 1, wherein managing memory and maintaining mappings comprises:
allocating memory in a rectangular heap in an application private address range for storing a static allocation of video data, the static allocation of video data not being directly accessible by the main processing unit;
finding a region in the address range of the graphics processing unit aperture large enough to store the static allocation of video data;
populating the found region with free pages; and
copying the static allocation of video data from the rectangular heap to the address range of the graphics processing unit aperture.

3. The method as recited in claim 2, wherein managing memory and maintaining mappings further comprises:
copying the static allocation of video data from the address range of the graphics processing unit aperture to the rectangular heap; and
unpopulating the found region of the graphics processing unit aperture.

4. The method as recited in claim 1, wherein managing memory and maintaining mappings comprises:
expanding a static allocation of video data to a multiple of a tile size of the graphics processing unit aperture;
allocating memory in a rectangular heap in an application private address range for storing the expanded static allocation of video data, the static allocation of video data not being directly accessible by the main processing unit;
finding a region in the address range of the graphics processing unit aperture large enough to store the unexpanded static allocation of video data;
locking the memory allocated in the rectangular heap; and
mapping the found region in the address range of the graphics processing unit aperture to the memory allocated in the rectangular heap.

5. The method as recited in claim 4, wherein managing memory and maintaining mappings further comprises:
unmapping the found region in the address range of the graphics processing unit aperture from the memory allocated in the rectangular heap; and
unlocking the memory allocated in the rectangular heap.

6. The method as recited in claim 1, wherein managing memory and maintaining mappings comprises:
allocating memory in a rectangular heap in an application private address range for storing a static allocation of video data, the static allocation of video data not being directly accessible by the main processing unit;
finding a region in the address range of the graphics processing unit aperture large enough to store the static allocation of video data;
locking the memory allocated in the rectangular heap; and
mapping the found region in the address range of the graphics processing unit aperture to the memory allocated in the rectangular heap.

7. The method as recited in claim 6, wherein managing memory and maintaining mappings further comprises:
unmapping the found region in the address range of the graphics processing unit aperture from the memory allocated in the rectangular heap; and
unlocking the memory allocated in the rectangular heap.

8. The method as recited in claim 1, wherein managing memory and maintaining mappings comprises:
allocating memory in a linear heap in an application private address range for storing a dynamic allocation of video data, the dynamic allocation of video data being directly accessible by the main processing unit;
finding a linear region in the address range of the graphics processing unit aperture large enough to store the dynamic allocation of video data;
locking the memory allocated in the linear heap; and
mapping the found region in the address range of the graphics processing unit aperture to the memory allocated in the linear heap.

9. The method as recited in claim 8, wherein managing memory and maintaining mappings further comprises:
unmapping the found region in the address range of the graphics processing unit aperture from the memory allocated in the linear heap; and
unlocking the memory allocated in the linear heap.

10. The method as recited in claim 8, wherein managing memory and maintaining mappings further comprises:
giving the address of the memory allocated in the linear heap to the application.

11. The method as recited in claim 1, wherein managing memory and maintaining mappings comprises:
allocating memory in a linear heap in an application private address range for storing a dynamic allocation of video data, the dynamic allocation of video data being directly accessible by the main processing unit;
finding a rectangular region in the address range of the graphics processing unit aperture large enough to store the dynamic allocation of video data;
locking the memory allocated in the linear heap; and
mapping the found region in the address range of the graphics processing unit aperture to the memory allocated in the linear heap.

12. The method as recited in claim 11, wherein managing memory and maintaining mappings further comprises:
unmapping the found region in the address range of the graphics processing unit aperture from the memory allocated in the linear heap; and
unlocking the memory allocated in the linear heap.

13. The method as recited in claim 11, wherein managing memory and maintaining mappings further comprises:
allocating a temporary buffer having an address;
untiling the dynamic allocation of video data from the memory allocated in the linear heap into the temporary buffer; and
giving the application the address of the temporary buffer to the application.

14. The method as recited in claim 13, wherein managing memory and maintaining mappings further comprises:
tiling the dynamic allocation of video data from the temporary buffer into the memory allocated in the linear heap; and
freeing the temporary buffer.

15. The method as recited in claim 1, wherein managing memory and maintaining mappings comprises:
allocating memory in a rectangular heap in an application private address range for storing a dynamic allocation of video data, the dynamic allocation of video data being directly accessible by the main processing unit;
finding a rectangular region in the address range of the graphics processing unit aperture large enough to store the dynamic allocation of video data;
populating the found region with free pages; and
tiling the dynamic allocation of video data from the memory allocated in the rectangular heap to the found address range of the graphics processing unit aperture.

16. The method as recited in claim 15, wherein managing memory and maintaining mappings further comprises:
rotating a virtual address for the dynamic allocation of video data from the found address range of the graphics processing unit aperture to the memory allocated in the rectangular heap, if the virtual address currently points to the found address range of the graphics processing unit aperture;
untiling the dynamic allocation of video data from the found address range of the graphics processing unit aperture to the memory allocated in the rectangular heap; and
unpopulating the found region of the graphics processing unit aperture.

17. The method as recited in claim 15, wherein managing memory and maintaining mappings further comprises:
rotating a virtual address for the dynamic allocation of video data from the memory allocated in the rectangular heap to the found address range of the graphics processing unit aperture, if the virtual address currently points to the memory allocated in the rectangular heap;
giving the address of the memory allocated in the rectangular heap to the application.

18. The method as recited in claim 1, wherein managing memory and maintaining mappings comprises:
allocating memory in a rectangular heap in an application private address range for storing a dynamic allocation of video data, the dynamic allocation of video data being directly accessible by the main processing unit;
finding a rectangular region in the address range of the graphics processing unit aperture large enough to store the dynamic allocation of video data;
populating the found region with free pages; and
tiling the dynamic allocation of video data from the memory allocated in the rectangular heap to the found address range of the graphics processing unit aperture.

19. The method as recited in claim 18, wherein managing memory and maintaining mappings further comprises:
rotating a virtual address for the dynamic allocation of video data from the found address range of the graphics processing unit aperture to the memory allocated in the rectangular heap, if the virtual address currently points to the found address range of the graphics processing unit aperture;
untiling the dynamic allocation of video data from the found address range of the graphics processing unit aperture to the memory allocated in the rectangular heap; and
unpopulating the found region of the graphics processing unit aperture.

20. The method as recited in claim 18, wherein managing memory and maintaining mappings further comprises:
evicting the dynamic allocation of video data from the found address range of the graphics processing unit aperture; and
giving the address of the memory allocated in the rectangular heap to the application.

21. The method as recited in claim 1, wherein managing memory and maintaining mappings comprises:
allocating memory in a rectangular heap in an application private address range for storing a dynamic allocation of video data, the dynamic allocation of video data being directly accessible by the main processing unit;
allocating memory in a linear heap in an application private address range for storing a dynamic allocation of video data, the dynamic allocation of video data being directly accessible by the main processing unit;
finding a rectangular region in the address range of the graphics processing unit aperture large enough to store the dynamic allocation of video data;
locking the memory allocated in the linear heap; and
mapping the found region in the address range of the graphics processing unit aperture to the rectangular heap.

22. The method as recited in claim 21, wherein managing memory and maintaining mappings further comprises:
rotating a virtual address for the dynamic allocation of video data from the found address range of the graphics processing unit aperture to the memory allocated in the rectangular heap, if the virtual address currently points to the found address range of the graphics processing unit aperture;
unmapping the found region in the address range of the graphics processing unit aperture from the rectangular heap; and
unlocking the memory allocated in the linear heap.

23. The method as recited in claim 21, wherein managing memory and maintaining mappings further comprises:
paging the dynamic allocation of video data into the found address range of the graphics processing unit aperture;
rotating a virtual address for the dynamic allocation of video data from the found address range of the graphics processing unit aperture to the memory allocated in the rectangular heap, if the virtual address currently points to the found address range of the graphics processing unit aperture; and
giving the address of the memory allocated in the rectangular heap to the application.

24. The method as recited in claim 21, wherein managing memory and maintaining mappings further comprises:
tiling the dynamic allocation of video data from the memory allocated in the linear heap to the memory allocated in the linear heap, if the dynamic allocation of video data was evicted.
